(19) United States
(12) Patent Application Publication
(10) Pub. No.: US 2026/0107930 A1
(43) Pub. Date: Apr. 23, 2026

(54) Embedded Line Cast Net Retrieval Device

(71) Applicant: Christopher A. Badeaux, Luling, LA (US)

(72) Inventor: Christopher A. Badeaux, Luling, LA (US)

(21) Appl. No.: 19/412,457

(22) Filed: Dec. 8, 2025

Related U.S. Application Data
(63) Continuation-in-part of application No. 18/824,755, filed on Sep. 4, 2024, now Pat. No. 12,495,778.
(63) Continuation-in-part of application No. 18/824,717, filed on Sep. 4, 2024, now Pat. No. 12,495,777.
(63) Continuation-in-part of application No. 18/824,744, filed on Sep. 4, 2024.

(51) Int. Cl. A01K 73/12; A01K 75/00

(52) U.S. Cl. CPC A01K 73/12; A01K 75/00

(57) ABSTRACT

An embedded horn line cast net retrieval device has a horn line embedded within a hand line, and a distal end of the horn line is foxed to a central retention aperture, that is defined by the central horn. The hand line extends defines an inner longitudinal passageway through which the horn line is slidably routed. A swivel connector at the distal end of the hand line includes a hollow cylindrical rod and an outer ring coupler having linkage arms connected to braille lines. A horn line stop restricts axial translation to promote bag net formation. Intermediate collars are disposed within the passageway of the hand line, and lateral slots are aligned with the collars to expose the horn line for selective pulling by a user. The device eliminates entanglement of the horn line with the braille lines.

### CROSS-REFERENCE TO RELATED APPLICATIONS

This application is related to and claims priority to co-pending and commonly owned U.S. application Ser. No. 18,824,717, filed on Sep. 4, 2024, U.S. application Ser. No. 18,824,744, filed on Sep. 4, 2024, and U.S. application Ser. No. 18,824,755, filed on Sep. 4, 2024, the full disclosure of all of which is hereby incorporated herein by reference in their entirety.

### BACKGROUND OF THE INVENTION

### Field of the Invention

The present disclosure relates generally to fishing nets and, more particularly, to cast net retrieving devices facilitating retrieval of cast nets snagged upon underwater obstructions by users without users having to enter the water.

### Description of the Related Art

Cast nets have been a staple tool for fishermen for centuries. Their simplicity and effectiveness make them a popular choice for catching baitfish and small fish in shallow waters. A well-thrown cast net spreads out like a large, circular curtain, blanketing an area of water, and trapping fish underneath. The retrieval process is straightforward in ideal situations: where a user simply pulls a hand line, which pulls the braille lines through the central horn and cinched the lead line at the bottom of the net closed, at which point the user pulls the cast net and respective catch to the surface and out of the water. However, a common challenge arises when retrieving the net, particularly when it becomes snagged on underwater obstructions in the water.

Snags can occur for a variety of reasons. Uneven bottoms with rocks, vegetation, or debris can snag the weighted edge of the net, preventing it from closing properly. Underwater obstacles, such as broken pilings often cause a cast net to be snagged and potentially tear when the user pull on the hand line when trying to retrieve the cast net.

When a cast net becomes snagged, the traditional retrieval methods often come with drawbacks. The most common approach is for the user to simply pull harder on the hand line. This can be effective for minor snags, but with a firmly lodged net, it can lead to hand line breakage, braille line breakage, or damage to the net itself. Most often, a user resorts to wading or even swimming into the water to free the net from the underwater obstruction. This can be inconvenient, time-consuming, and even dangerous depending on the depth of the water, the current conditions, or the user's physical capabilities. Cold water, strong currents, or slippery rocks can all pose significant safety hazards. Additionally, murky or deep water can make it very difficult to locate the snag and thus very difficult to effectively free the net from the underwater obstruction. Dealing with snagged cast nets also amounts to lost fishing time while out over the water.

Moreover, when snagged cast nests are not able to be retrieved from the underwater obstructions, then the cast nets are left in the water and pose a danger to the local wildlife and habitat.

The limitations of traditional retrieval devices and methods highlight the need for a more user-friendly and safer way to handle and retrieve snagged cast nets. There is a need for cast net retrieving devices and methods that allows users to free a snagged net from an underwater obstruction without having to enter the water. There is a need for a cast net retrieving device that also minimizes the risk of line breakage or net damage during retrieval of a snagged cast net.

Moreover, a need exists for new and improved cast net retrieval devices and swivel connectors that overcome the limitations of horn line entanglement with braille lines.

In addition, with conventional cast net devices, cast net fishermen typically experience the central horn of a cast net device dropping down to abut the lead line gathering when the cast net webbing is uplifted out of the water, upon an upward pulling of the braille lines by a fisherman. Such limitations of conventional devices cause the fishermen's catch to get stuck or trapped at the top of the cast net webbing when lifting up the cast net from the floor of the waterway, and dropping the lead line gathering onto their boat, dock or pier, leaving their catch draped down out of reach, as especially seen with larger cast nets. During retrieval, the upward pull on the lead line from the outer edge cinches the net mouth shut against the central horn. As the lead line rises, the inner side of the webbing is dragged across the outer edge of the cinched/gathered lead line, which pushed and chases the fish/shrimp against the internal mesh and thereby trapping the catch into the webbing mesh (by their own external morphology. This activated the aquatic vertebrates'lateral line system (senses of the catch), the catch senses movement, vibration, pressure changes and pressure gradients.

Such extensive pulling on the braille lines to uplift the lead line, causing the lead line gathering, imparts extensive wear and tear on the fishermen's hands. Therefore, a need exists for cast net retrieval devices that facilitate more efficient and ergonomical uplifting of the braille lines and respective lead lines by limiting braille line movement and respective lead line movement relative to the central horn, while also achieving the goal of uplifting the lead line out of the water. New devices are needed to limit the central horn from sliding down to the lead line.

Moreover, new devices are needed that facilitate uplifting of the fishermen's catch within the cast net mesh in conjunction with the lead line of the cast net devices, thereby facilitating easier and more efficient release of the catch from the uplifted cast net device on fishermen's boats, docks and piers.

A need further exists for new and improved cast net retrieval devices having horn line features that prevent lead line interference with the central horn when withdrawing a cast net out of water. Improved cast net devices are needed that obviate the need for users to physically grasp tops of cast nets by limiting movements of the lead line relative to the central horn, while accomplishing the goals of retrieving snagged cast nets from underwater obstructions.

A need further exists for new and improved cast net swivel devices that separate braille lines and reduce entanglement between the horn line and the braille lines.

### SUMMARY OF THE INVENTION

The following presents a simplified summary of the present disclosure in a simplified form as a prelude to the more detailed description that is presented herein.

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

The present disclosure provides an embedded horn line cast net retrieval device that improves upon and expands the functionality of earlier cast net retrieval devices. This embodiment embeds the horn line within the hand line itself, thereby confining the horn line to an inner longitudinal passageway of the hand line. Through embodiments disclosed and detailed herein, the embedded horn line cast net retrieval device system enhances structural stability, prevents any likelihood of entanglement with any braille lines because the horn line is embedded inside of the hand line, minimizes abrasion during repeated cycles of casting and retrieval, and enables controlled formation of a bag net configuration during use.

Therefore, in accordance with embodiments of the invention, there is provided an embedded horn line cast net retrieval device comprising a cast net body having a net webbing terminating at a weighted lead line, and a central horn affixed to an upper portion of the cast net body. The central horn defines a central retention aperture to which a horn line is secured. The hand line extends outwardly from the cast net body, the hand line having a proximal end opposite a distal end and further defining a proximal portion and a distal portion. The hand line includes an inner longitudinal passageway extending substantially along its length through which the horn line slidably extends. The horn line has a proximal end opposite a distal end, with the proximal end secured to the proximal end of the hand line, and the distal end secured to the central retention aperture of the central horn.

In a preferred embodiment, the distal end of the horn line is fixed to the central retention aperture, from a vertical standpoint relative to the central horn, while the horn line remains able to spin (or rotate) freely within the central retention aperture of the central horn.

The distal portion of the hand line is operatively connected to a swivel connector. The swivel connector includes a hollow cylindrical rod having a top section preferably formed with external ridges, and a lower section having a smooth outer surface. An outer ring coupler pivotally engages the smooth outer surface of the hollow cylindrical rod, permitting relative rotation. The outer ring coupler supports an opposing pair of linkage arms, each linkage arm operatively connected to a respective set of braille lines. The braille lines slidably extend through the central horn of the cast net body and terminate with their distal ends secured to the weighted lead line. This arrangement permits rotational alignment and balanced force distribution across the cast net body during both casting and retrieval. In the preferred embodiment, since two sets of braille lines are connected to the two respective linkage arms of the opposing pair of linkage arms of the swivel connector, then entanglement between the horn line and braille lines is reduced, abrasion and wear are minimized, and user handling is improved. That is because the braille lines are spread apart by the two linkage arms.

In one embodiment, the horn line further comprises a horn line stop disposed within the hand line above the cylindrical rod of the swivel connector. The horn line stop is dimensioned with an outer diameter greater than that of the cylindrical rod, such that when the horn line stop abuts the hollow cylindrical rod, further axial translation of the horn line is prevented. This cooperative arrangement restricts axial motion of the horn line during cast net retrieval, by maintaining the central horn in an elevated position relative to the weighted lead line and thereby forming a bag net structure in the net webbing.

The horn line stop may be provided in several alternative forms. In one embodiment, the horn line stop is clamped onto the horn line. In another embodiment, the horn line stop is formed integrally with the horn line by molding, reducing manufacturing complexity and improving durability.

In certain embodiments, the horn line stop comprises a diameter greater than the diameter of the top of the cylindrical rod of the swivel connector, such that the horn line stop cooperates with the swivel connector to limit axial translation of the horn line within the hand line during retrieval, thereby promoting controlled bag net formation.

In further embodiments, a compression ring is disposed around the distal end of the hand line, securing the distal end of the hand line to the ridged top section of the hollow cylindrical rod of the swivel connector. The compression ring provides mechanical reinforcement to prevent slippage during repeated casting cycles.

In yet another embodiment, the horn line further comprises at least one weight disposed within the hand line near the distal end of the hand line, positioned above the cylindrical rod of the swivel connector. In a preferred embodiment, the horn line operatively slidably extends through the weight, which, preferably has a hollow cylindrical body through which the embedded horn line slidably extends.

In an additional embodiment, the horn line includes a colored marker near its proximal end. The colored marker is visible through the first exit aperture of the hand line and provides a visual indication to the user when sufficient length of the horn line has been pulled outward to alleviate tension in the braille lines, thereby informing the fisherman of operational alignment.

In another embodiment, the embedded horn line cast net retrieval device comprises a plurality of intermediate collars embedded within the inner longitudinal passageway of the hand line. The intermediate collars are spaced sequentially along the inner longitudinal passageway and are adapted to provide slidable engagement with the horn line. The hand line further comprises a plurality of lateral slots aligned with the intermediate collars, each lateral slot serves at an access point by exposing a respective portion of the horn line. This arrangement permits the user to grasp and pull the horn line at multiple access points along the hand line. Such embodiments provide enhanced control of retrieval forces by a user, by selectively pulling on respective portions of the hand line (outwardly of the hand line from which the horn line is embedded), at the access points of the lateral slots that expose such portions.

The intermediate collars may be composed of low-friction materials such as polytetrafluoroethylene, ultra-high-molecular-weight polyethylene, acetal, or ceramic bushings. The use of these materials reduces wear and allows repeated operation under wet conditions without degradation of performance.

In some embodiments, the lateral slots may be elongated, circular, or oval, and may include reinforcing grommets or molded edges to prevent fraying of the hand line and provide tactile guidance. In a preferred embodiment, the horn line is color-coded at various points along the horn line to identify pull points visible at the access point slots, to help a fisherman (user) better know when all tension has been alleviated from the braille lines, as the tension forces are transferred to the horn line.

In another embodiment, the horn line includes a color-coded segment to indicate operational alignment, providing an additional visual cue to the fisherman during retrieval from a snag upon the underwater obstruction.

In yet another embodiment, the device includes a fixed horn line arrangement in which the proximal end of the horn line comprises a horn line stop disposed atop the swivel connector. In this configuration, the horn line stop is adapted to limit axial movement of the horn line through the swivel connector and thereby restrict axial movement of the central horn during casting. This limitation of axial movement promotes the formation of a bag net configuration within the net webbing.

Alternative embodiments may vary the number, spacing, and composition of intermediate collars, the size and shape of lateral slots, and the materials of construction for the hand line, swivel connector, and central horn. For example, three to seven intermediate collars may be employed, compression rings may be formed of stainless steel or polymer composites, and the central horn may be fabricated of polymeric resin, lightweight aluminum, or titanium alloy.

Collectively, the embedded horn line cast net retrieval device provides significant operational advantages. By embedding the horn line within the hand line, entanglement between the horn line and the hand line is obviated, tangling with braille lines is reduced, abrasion and wear are minimized, and user handling is improved. The cooperative arrangement of the horn line stop, proximal coupler, intermediate collars, lateral slots, compression ring, optional weights, and colored marker enables controlled positioning of the central horn relative to the weighted lead line, promotes formation of a bag net, improves catch retention, and simplifies catch release. These features represent a substantial improvement over conventional devices and designs. As further detailed below, the new and improved disclosed swivel prevents the braille lines from entangling with the horn line.

The present disclosure further provides an offset swivel connector configured to improve angular line alignment and reduce torsional resistance during retrieval of the cast net body. The offset swivel connector includes a curved intermediate portion extending between an upper coupling section and a lower linkage interface, the curved intermediate portion defining a bend junction oriented at an acute angle relative to the longitudinal axis of the hand line. This offset geometry repositions the lower linkage interface rearwardly, creating a more linear pull path for the horn line through the swivel connector during retrieval operations. As a result, rotational binding of the outer ring coupler is minimized, allowing smoother elevation of the central horn and reduced twisting of the braille lines. The offset swivel connector may be fabricated from stainless steel, anodized aluminum, or brass, with the radius of curvature selected to correspond to the overall size of the cast net and to maintain consistent mechanical stability during repeated casting and retrieval cycles.

In further embodiments, a cast net device is provided that includes a net webbing having distinct annular regions formed with differing mesh geometries to improve hydrodynamic and snag-resistance performance. The net webbing has a lower portion and an upper section. The lower portion of the net webbing includes a lower annular band disposed directly adjacent a weighted lead line, while the upper section includes an upper annular band contiguous with and positioned above the lower annular band. In a preferred embodiment, the lower annular band has a first mesh opening size smaller than that of the upper annular band, thereby providing a reinforced fine-mesh region configured to resist snagging on sticks, rocks, and underwater obstructions during retrieval while maintaining smooth deployment of the cast net.

In certain embodiments, the lower annular band extends vertically for approximately ten to sixteen inches above the weighted lead line and may employ mesh openings of approximately five-eighths of an inch. The upper annular band, by contrast, may utilize larger mesh openings of about one inch or greater, thereby facilitating efficient water flow and a rapid descent of the net body when cast. A transition between the two bands is defined by a circumferential seam joining the filaments of the respective meshes to create a continuous integrated webbing structure that maintains uniform strength distribution.

In preferred forms, the lower annular band is formed of a smaller-mesh monofilament section designed to reduce lodging of debris and vegetation while not materially impeding the sink rate of the net relative to the upper annular band. The upper portion of the net webbing may be secured to a central horn by sewing or integrating its top edge directly into a bottom ring of the central horn to provide a reinforced attachment point. The lower and upper annular bands may be fabricated from polymeric filamentary materials such as nylon, polyester, polyethylene, or combinations thereof, with the filament gauge of the lower annular band equal to or greater than that of the upper annular band to enhance abrasion resistance near the lead line region.

These features collectively provide an improved cast net that maintains optimal deployment and retrieval characteristics while offering superior durability and resistance to fouling, thereby improving performance and longevity in commercial and recreational cast-netting applications.

Alternative embodiments may further vary the materials and dimensions of the couplers, horn line, and central horn to optimize performance for recreational or commercial fishing applications. Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1A-1E are perspective views of a cast net retrieving device comprising a dual line cast net retrieving device, in accordance with embodiments of the invention;

FIG. 1F illustrates an example view of the cast net body in relation with the snag, in accordance with embodiments of the invention;

FIG. 1G illustrates an example scenario where the cast net retrieving device with the horn line and coupler assembly encounters a snag, in accordance with embodiments of the invention;

FIG. 1H illustrates a detailed view of the cast net retrieving device with the horn line and coupler assembly in accordance with embodiments of the invention;

FIG. 1I illustrates an example operation of the cast net retrieving device with the horn line and coupler assembly, in accordance with embodiments of the invention;

FIG. 1J illustrates a schematic view of connection assembly of the hand line and the horn line using the coupler, in accordance with embodiments of the invention;

FIG. 1K illustrates a schematic design of the coupler, in accordance with embodiments of the invention;

FIG. 1L illustrates a schematic design of arrangement of a proximal end of a horn line fixed to a hand line, in accordance with embodiments of the invention;

FIG. 1M illustrates a schematic view of arrangement of different connectors on ends of the hand line and the horn line, in accordance with embodiments of the invention;

FIGS. 2A to 2D illustrate different perspective views of a cast net retrieval device comprising a horn hook and a horn line, in accordance with embodiments of the invention;

FIG. 2E refers to another embodiment of the cast net retrieving device comprising a horn hook, in accordance with embodiments of the invention;

FIG. 2F illustrates a left perspective view of another embodiment of a cast net retrieving device comprising a horn hook, in accordance with embodiments of the invention;

FIG. 2G depicts a partial left side elevational view of the horn hook engaging a net webbing, in accordance with embodiments of the invention;

FIG. 2H depicts another partial left side elevational view of the horn hook removably connected to the net webbing of FIG. 2G, in accordance with embodiments of the invention;

FIG. 3A refers to another embodiment of the cast net retrieving device with a tube joint, in accordance with embodiments of the invention;

FIG. 3B refers to a schematic view of a pulling action of the horn line from the tube joint, in accordance with embodiments of the invention;

FIG. 3C refers to another schematic view of a pulling action of the horn line from the tube joint, in accordance with embodiments of the invention;

FIG. 3D refers to another schematic view of an extended view of the horn line, in accordance with embodiments of the invention;

FIG. 3E refers to another schematic view of a pulling action of the horn line and respective net webbing of the cast net body, in accordance with embodiments of the invention;

FIG. 4 illustrates swivel connector, in accordance with embodiments of the invention;

FIG. 5 illustrates a perspective view of a swivel, in accordance with embodiments of the invention;

FIG. 6 illustrates an elevational view of a swivel connector, in accordance with embodiments of the invention;

FIG. 7A illustrates a top view of a central horn, in accordance with embodiments of the invention;

FIG. 7B illustrates a side elevation view of a central horn, in accordance with embodiments of the invention;

FIG. 8 illustrates an elevation view of a swivel connector, in accordance with embodiments of the invention;

FIG. 9 illustrates a side elevation of a choker hitch connector line, in accordance with embodiments of the invention;

FIG. 10 illustrates front elevation view of a dual line cast net retrieval device, in accordance with embodiments of the invention;

FIG. 11 illustrates a side elevation view of a dual line cast net retrieval device, in accordance with embodiments of the invention;

FIG. 12 illustrates a close-up perspective of a central horn with a horn line connected to the central horn aperture, in accordance with embodiments of the invention;

FIG. 13A illustrates a perspective view of a dual line cast net retrieval device, in accordance with embodiments of the invention;

FIG. 13B illustrates a perspective view of a dual line cast net retrieval device and exemplary net webbing, in accordance with embodiments of the invention

FIG. 14 illustrates an elevational view of a dual line cast net retrieval device and a three-dimensional central horn, in accordance with embodiments of the invention;

FIG. 15 illustrates a side elevational view of a dual line cast net retrieval device, in accordance with embodiments of the invention;

FIG. 16 illustrates a perspective view of an embedded horn line cast net retrieval device, in accordance with embodiments of the invention;

FIG. 17 illustrates another perspective view of an embedded horn line cast net retrieval device, in accordance with embodiments of the invention;

FIG. 18 illustrates a perspective view of a lower section of perspective view of an embedded horn line cast net retrieval device, in accordance with embodiments of the invention;

FIG. 19 illustrates a front elevation view of an embedded horn line cast net retrieval device, in accordance with embodiments of the invention;

FIG. 20 illustrates a perspective view of a top section of a perspective view of an embedded horn line cast net retrieval device, in accordance with embodiments of the invention;

FIG. 21 illustrates perspective view of an embedded horn line cast net retrieval device with a three-dimensional horn, in accordance with embodiments of the invention;

FIG. 22 illustrates another perspective view of an embedded horn line cast net retrieval device with a three-dimensional horn, in accordance with embodiments of the invention;

FIG. 23 illustrates a front elevation view of a fixed horn line cast net retrieval device, in accordance with embodiments of the invention;

FIG. 24 illustrates a front perspective view of a fixed horn line cast net retrieval device, in accordance with embodiments of the invention;

FIG. 25 illustrates perspective view of another embedded line cast net retrieval device, in accordance with embodiments of the invention;

FIG. 26 illustrates a front elevation view of a curved swivel device of a cast net retrieval device, in accordance with embodiments of the invention;

FIG. 27 illustrates a side elevation view of the curved swivel device of the cast net retrieval device of FIG. 26, in accordance with embodiments of the invention; and

FIG. 28 illustrates a front elevation view of a dual mesh size cast net device, in accordance with embodiments of the invention.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to fishing nets. Herein, cast net retrieving devices are disclosed that allow users to free a snagged cast net without the user having to enter into the water, while avoiding breakage of the braille lines of the cast net, regardless of water conditions.

As can appreciated from this detailed disclosure, include the Figures and appended claims, one of ordinary skill in the art could appreciate that the embodiments of the disclosed inventions herein also enable a fisherman to release a catch, such as an alligator, that would otherwise break the cast net, without the user having to enter into the water, while avoiding breakage of the braille lines of the cast net.

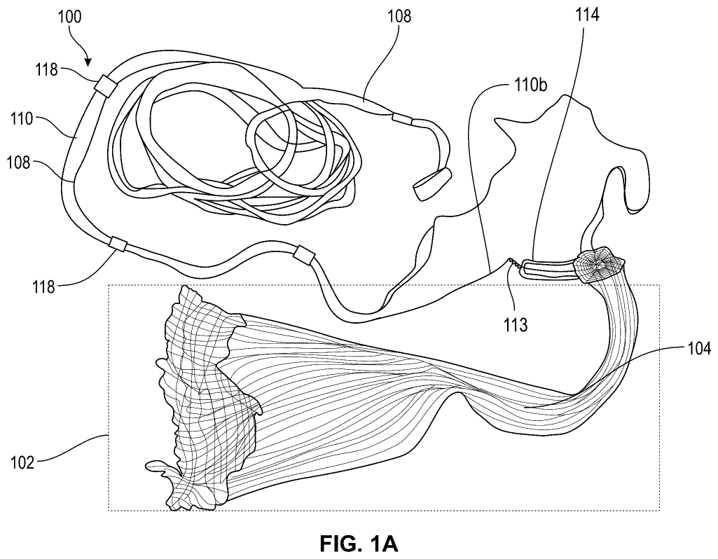

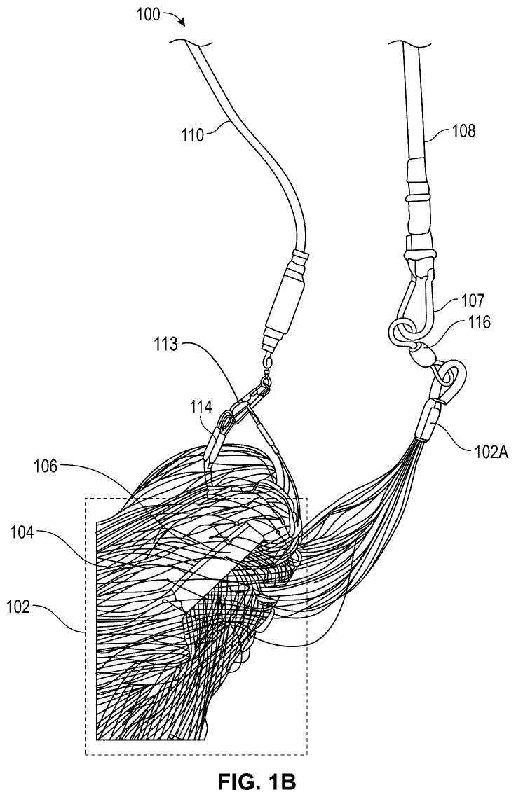

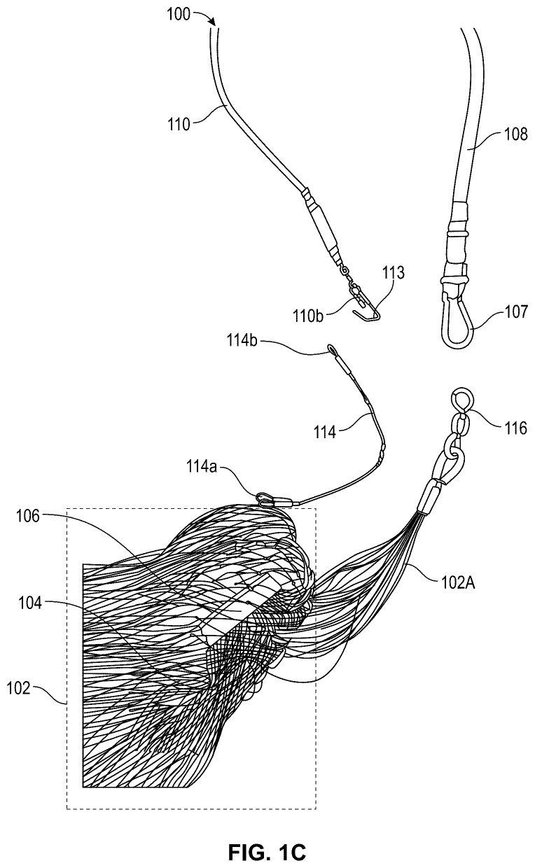

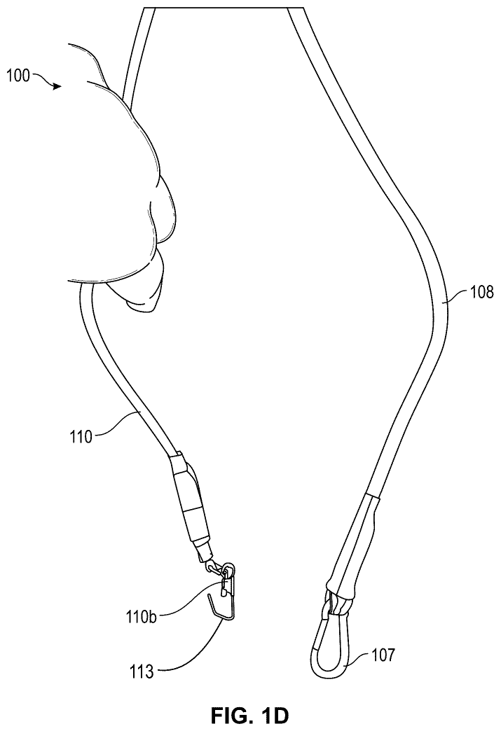

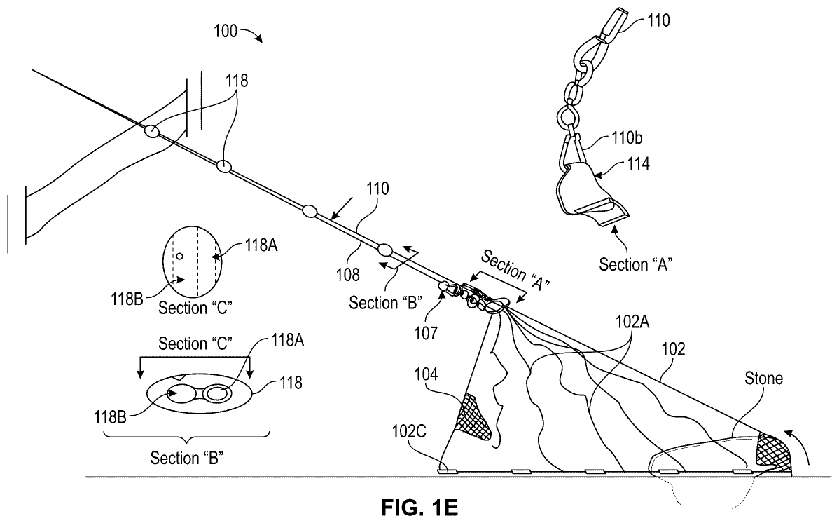

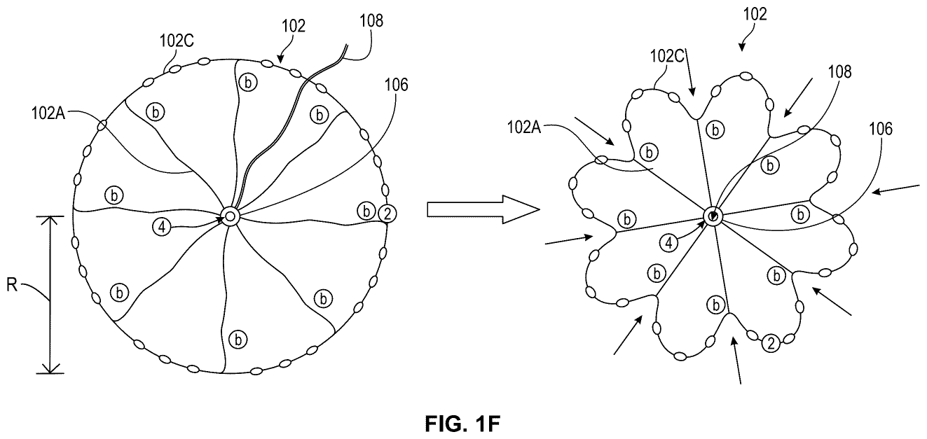

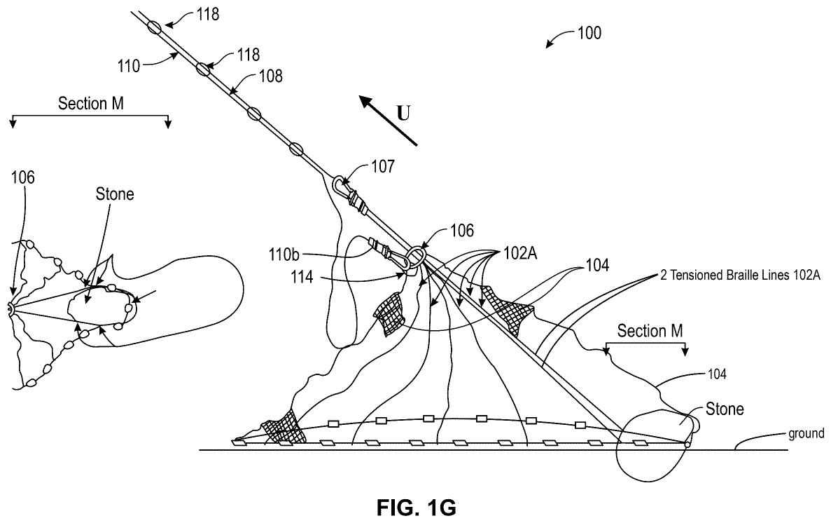

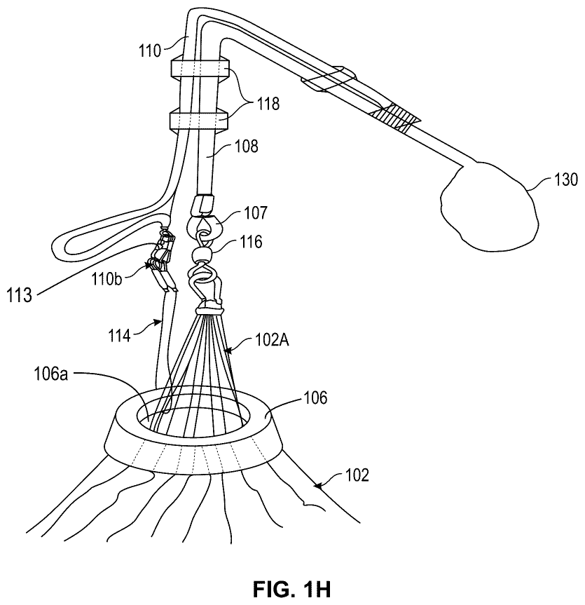

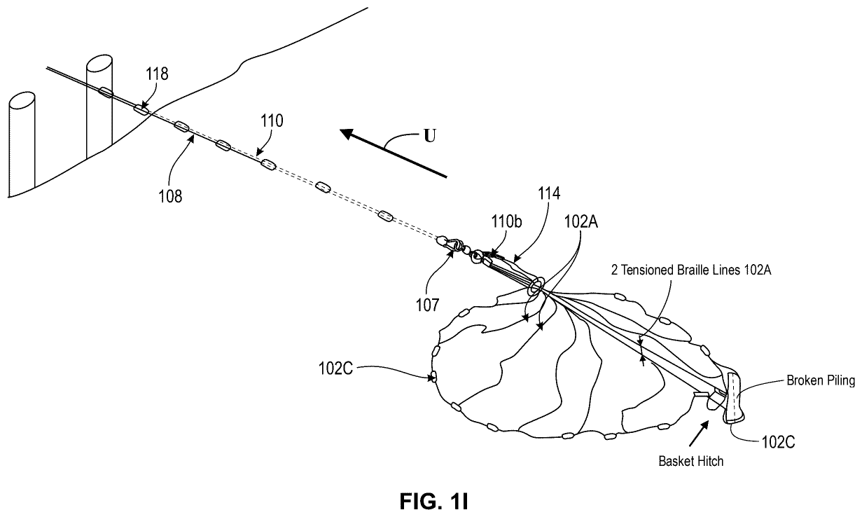

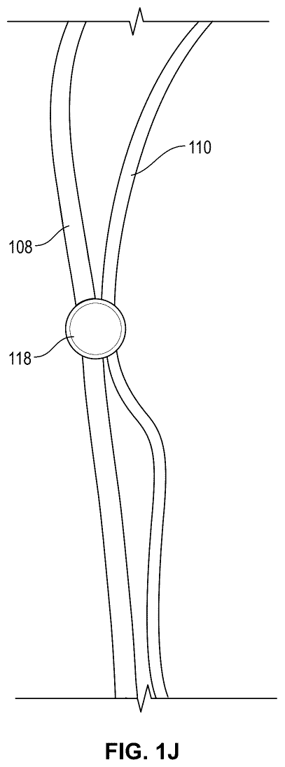

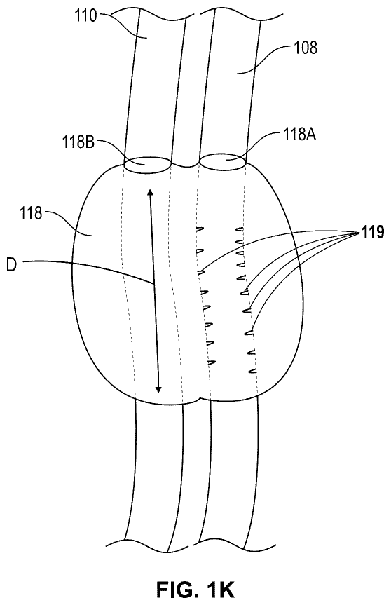

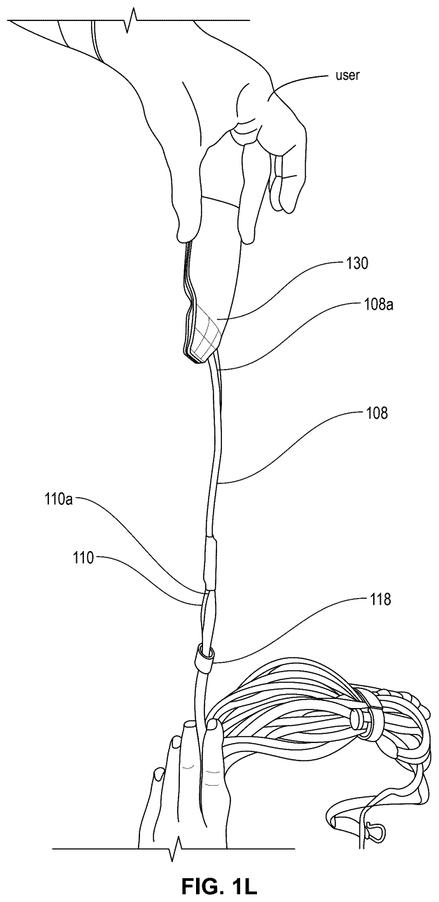

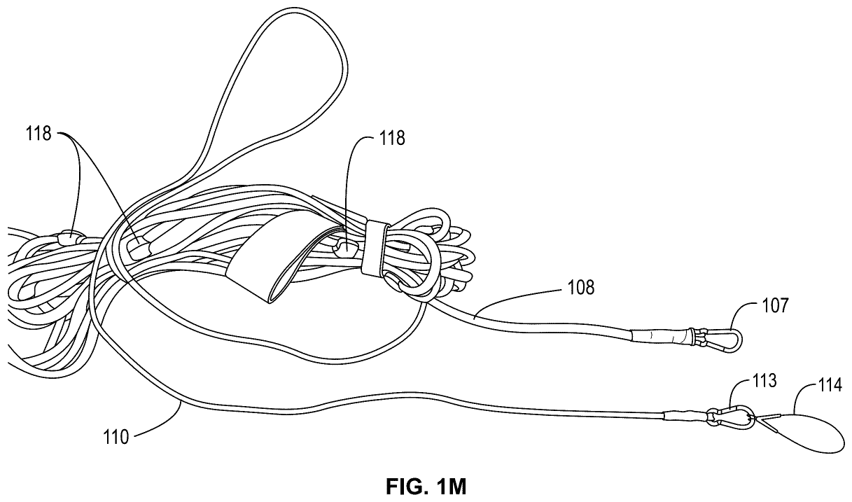

Referring to FIGS. 1A to 1E, a cast net retrieving device 100 is disclosed comprising a cast net body 102 having a central horn 106 connected to a net webbing 104. The central horn 106 has an opening 106a. The net webbing 104 has a weighted lead line at a distal end thereof. The cast net body 102 is adapted to be thrown by a user into a water body for fishing. The cast net body 102 further comprises a lead line 102C with a plurality of weights, as illustrated in FIGS. 1E-1G

In one embodiment, the cast net retrieving device 100 comprises a hand line 108, a horn line 110, and a plurality of couplers 118. The disclosed cast net retrieval device is a dual line device.

The hand line 108 has a proximal end 108a opposite a distal end 108b. The distal end 108b is removably connected to, or adapted to connect to, a swivel 116 of the cast net body 102, as seen in FIG. 1B-1D. The swivel 116 is connected to the plurality of braille lines 102A that slidably extend through the central horn 106 of the cast net body 102. The braille lines 102A have respective distal ends connected to the weighted lead line 102C, as illustrated in FIG. 1E-1G.

Referring to FIG. 1B-1D, in a preferred embodiment, the hand line 108 is configured with a spring-loaded hook 107 that removably connects the hand line 108 to the swivel 116. Respective proximal ends of the plurality of braille lines 102A are connected to the swivel 116.

The horn line 110 has a proximal end 110a opposite a distal end 110b, and in a preferred embodiment, the horn line 110 is operatively connected to the hand line 108 through the plurality of couplers 118, as illustrated in FIG. 1E and FIG. 1G-1K.

Referring to FIG. 1J-1K, preferably, at least one coupler 188 of the plurality of couplers defines a line retainer 118a and also defines a line passageway 118b adjacent to the line retainer 118a. The line retainer 118a is preferably fixed to a portion 109 of the hand line 108, that extends therethrough and outwardly each end thereof. In other words, the line retainer 118a is connected to a portion 109 of the hand line 108 at a fixed position.

The line passageway 118b of the at least one coupler operatively slidably received the horn line 110 therethrough in a sliding engagement. In other words, respective portions 109 (109a, 109b, 109c, etc) of the hand line 108 are respectively fixed inside each of the plurality of couplers 118, and the horn line 110 slides through the plurality of couplers 118 when pulled upon by a user.

In one embodiment, a length of the horn line 110 is at least 1 foot greater than a length of the hand line 108. In yet another embodiment, a length of the horn line 110 is at least 4 feet greater than a length of the hand line 108, as illustrated in FIGS. 1A, 1G, and 1H.

In a preferred embodiment, a preferred length of the horn line 110 is longer than a length of the hand line 108 by a length that is equal to (or longer than) a length of a radius (R) of the cast net, as illustrated in FIG. 1F. For example, a 6-foot cast net can a radius (R) of 6 feet, which is the distance from the central horn 106 to the lead line 102C. When opened, the net will unfold into a circle that is 12 feet across in diameter, which is twice the radius (R). Thus, in this example, in a preferred embodiment, a length of the horn line 110 is longer than a length of the hand line 108 by a length that is equal to 6 feet, because that is the length of the radius of the cast net, in this illustrative example.

In a preferred embodiment, the distal end 110b of the horn line 110 is connected to the central horn 106 of the cast net body 102, as illustrated in FIG. 1A-1C. In a preferred embodiment, the horn line 110 is connected to the central horn 106 through a basket hitch connector 114. The basket hitch connector 114 forms a loop around the central horn, and ends of the basket hitch connector 114 are connected to a horn line clasp 113 of the horn line 110, as exemplified in FIG. 1B.

The horn line 110 is removably connected to, and also adapted to removably connect to, the central horn 106 of a cast net through a basket hitch connector 114, as illustrated in FIG. 1C and FIG. 1H. The basket hitch connector 114 is disposed at a distal end of the horn line 110. The basket hitch connector 114 forms a loop around the central horn 106 via the opening 106a, and the respective ends 114a, 114b of the basket hitch connector 114 are each connected to a horn line clasp 113 which is removably connected to the distal end 110b of the horn line 110.

The horn line 110 is adapted to exert an uplifting force upon the central horn 106 and the connected net webbing 104, at the option of the user, upon a horn line 110 pulling by the user of the horn line 110 through the couplers 118. The uplifting force is configured to alleviate tension in the braille lines 102A when the weighted lead line 102C and net webbing 104 is snagged upon an underwater obstruction, such as a broken piling.

Referring to FIG. 1E and FIG. 1G, it can be seen that the horn line 110 is pulled by a user in the direction of Arrow U to remove the cast net body 102 from an underwater obstruction, as further described and detailed herein. When the horn line 110 is pulled by a user, the couplers 118 allow the horn line 110 to freely move inside the couplers and provide control over the central horn 106, in order to raise the cast net body 102 upwards, off of the underwater obstruction. The upward pulling upon the central horn 106 allows the braille lines 102A to relax as the tension is released from the braille lines 102A, which enables the net webbing 104 and lead line 102C to slide off from the snag, which allows the cast net body 102 to be raised upwards out of the water, without breaking the braille lines 102A.

Referring to FIG. 1K, in one embodiment, at least one coupler 118 defines two adjacent openings, where one opening 118a is a line retainer 118a through which the hand line 108 is extended therethrough, and the line retainer 118a is fixed to a portion 109 of the hand line 108. The other opening 118b is a line passageway 118b through which the horn line 110 operatively extends and engages in a sliding arrangement. In such manner, the horn line 110 is adapted to slide through the at least one coupler 118 by sliding through the line passageway 118b, in the direction of Arrow D, when pulled upon by a user, as illustrated in FIG. 1K. Preferably, all couplers 118 define the two adjacent openings, respectively, including the line retainer 118a and the line passageway 118b. In such embodiment, the respective line retainers 118a of the respective couplers 118 are each fixed to a respective portion 109 of the hand line 108, preferably in a spaced apart relation along the hand line 108. This spaced apart positioning of the couplers 118 along the hand line 108 allows for easy access for a user's hands to grasp the couplers 118 and respective portions of the hand line 108 during the user's retrieval of the cast nest from the body of water. In other word, in a preferred embodiment, the plurality of couplers 118 are respectively fixed to the hand line 108 at spaced apart locations, respectively, preferably spaced 18″ apart from each other along the hand line 108, because such preferred spacing can aid the user in pulling and uplifting the hand line 108 when retrieving the cast net out of a body of water. That is because the couplers 118 provide for additional gripping for the user's hands, by providing additional frictional resistance to the hand line 108. Referring to FIG. 1L, in a preferred embodiment, a proximal end 110a of the horn line 110 is fixed to said hand line 108 approximately one foot below an elastic wristband 130 that is attached to a proximal end 108a of the hand line 108, to help keeping the horn line 110 clear of a user's hand grip on the elastic wristband 130. FIG. 1M illustrates a schematic view of arrangement of different connectors on ends of the hand line 108 and the horn line 110.

The couplers 118 provide an operative connection between the hand line 108 and the horn line 110. The couplers 118 allow for a smooth transition between an initial pulling of the hand line 108 and a subsequent upward pulling (deploying) of the horn line 110 during retrieval of the cast net body 102 from a snag upon an underwater obstruction. The couplers 118 also ensure a firm and reliable hold by a user's hands on both the hand line 108 and the horn line 110 by providing gripping points for the user. This minimizes the risk of lines slipping loose during the retrieval process.

In one embodiment, the hand line 108 is a strong, durable line specifically designed for withstanding the pulling force exerted during retrieval of the cast net body 102 from the water. The hand line 108 is preferably made of braided nylon or similar material for a good balance of strength and manageability.

In one embodiment, the horn line 110 is a flexible steel cable. In other embodiments, the horn line 110 is fabricated of a flexible material selected from the group consisting of steel cable, braided nylon, and synthetic fiber, and combinations thereof. For a synthetic fiber, the horn line 110 is preferably fabricated of polypropylene, nylon, polyesters (e.g. PET, LCP, Vectran), polyethylene (e.g., Dyneema® and Spectra®), Aramids (e.g., Twaron®, Technora®, and Kevlar®) and/or acrylics (e.g., Dralon®).

Referring to FIG. 1H, the spring-loaded hook 107 that is disposed on the distal end 108b of the hand line 108 is adapted to quickly and securely attach to the swivel 116, at the option of the user.

Since the distal end 110b of the hand line 108 and the distal end 110b of the horn line 110 are removably attachable to the swivel 116 and the central horn 106, respectively, embodiments of the dual line cast net retrieval device 100 can be used with conventional cast nets.

The swivel 116 allows smooth rotation of the hand line 108 relative to the connected braille lines 102C while the hand line 108 is pulled, preventing the net from twisting. Simultaneously, tension on the hand line 108 is evenly distributed across the cast net body 102 through the braille lines 102A. This even distribution helps close the net's pouch efficiently, capturing fish within its confines.

FIG. 1F refers to an illustrative view of an exemplary cast net body 102. Before the retrieval process begins, the cast net body 102 rests on the bottom of the body of water in a fully deployed state. The net webbing 104 of the cast net body 102 is typically made of a lightweight mesh material. In its initial state, the net webbing 104 is fully spread out, creating a large, circular opening designed to capture fish. It rests flat on the bottom, maximizing its coverage area. The braille lines 102A are a series of lines that radiate outwards from the swivel 116 and connect to various points within the net webbing 104. When the cast net body 102 is deployed, the braille lines 102A are relaxed with minimal tension. This allows the net webbing 104 to fully expand and open.

The hand line 108 is pulled by the user to retrieve the cast net body 102. In the initial state, the hand line 108 is also relaxed with minimal tension. It may be coiled or loosely held in the user's hand, ready to be pulled for retrieval.

The lead line 102C is a weighted line that runs along the bottom edge of the net webbing 104. The purpose of the weighted lead line 102c is to help spread open the cast net webbing during deployment by a user over a body of water and to help sink the net quickly in the water. Depending on the specific design, the lead line 102C may be incorporated, and in its initial state, the lead line 102C would also be resting on the bottom with minimal tension.

During retrieval, the user begins pulling the hand line 108. This creates tension that travels through the entire cast net body 102. As the hand line 108 is pulled, the cast net body 102 starts to gather toward the center and then rise from the bottom or ground of the waterbody. Ideally, the net is lifted straight up with minimal tilting, ensuring a centered retrieval. The pulling on the hand line 108 translates to tightening of the braille lines 102A. The braille lines 102A, previously relaxed, become taut as they bear the weight of the net and any captured fish or stone.

The lead line 102C, while still resting on the bottom to some degree, experiences a shape change. As the braille lines 102A are pulled towards the center, the lead line 102C is no longer perfectly circular. Those of ordinary skill in the art can imagine the lead line 102C bunching slightly inwards, following the converging braille lines 102A. If the cast net body 102 is not lifted perfectly centered, some braille lines 102A may experience more tension than others. This can create larger loops in the lead line 102C between the points of connection of the braille lines 102A, potentially snagging on the bottom debris or uneven terrain of the bottom of the waterbody.

FIG. 1G refers to an example scenario where the cast net retrieving device 100 with a horn line 110 and coupler assembly 118 encounters the snag (stone). This occurs, for example, when an underwater obstruction such as a stone becomes lodged in the lead line 102C, which is the weighted edge of the cast nest. Section M specifically highlights the impact and strain on the braille lines 102A resulting from a snag of the net webbing 104 and lead line 102C on the underwater obstruction, the exemplary stone.

Typically, when the lead line 102C is snagged and caught up on an underwater obstruction, two braille lines 102A (called out as “2 Tensioned Braille Lines 102A” in FIG. 1G and in FIG. 1I) become over tensioned because they are pulling on the respective portions of the lead line 102C that is snagged around the underwater obstruction, such as the stone exemplified in FIG. 1G and the broken piling exemplified in FIG. 1I, in effect forming a basket hitch around the stone, thereby preventing the cast net body 102 from being retrieved from the water. That is because a pulling of the hand line 108 and respectively connected braille lines 102A typically causes those two braille lines 102A to be squeezed towards the stone, of which the lead line 102C is wrapped around, as illustrated in FIG. 1I. This suggests these specific braille lines 102A are experiencing the greatest tension as they attempt to pull the lodged stone upwards.

Further, as exemplified in FIG. 1G, all of the other braille lines 102A are relaxed. This indicates that the snag is causing an uneven distribution of force on the two specific braille lines 102A (called out as “2 Tensioned Braille Lines 102A” in FIG. 1G and in FIG. 1I) that are forming the basket hitch, with the lead line 102C, around the underwater obstruction, the stone. Merely pulling harder on the hand line in an upward direction (Arrow U) would only tighten the basket hitch thereby causing the lead line 102C to become more snagged or more stuck on the underwater obstruction. Embodiments of the invention disclosed herein enable the cast net body 102, including net webbing 104, braille lines 102A and lead line 102C, to be freed, or removed from, the underwater obstruction. Through embodiments of the invention disclosed herein, the user can undertake a direct upward pulling on the central horn 106 of the cast net body 102, which alleviate the tension in the two specific braille lines 102A (the “2 Tensioned Braille Lines 102A” in FIG. 1G and in FIG. 1I), which in effect releases the basket hitch otherwise formed, because the central horn 106 is connected to the net webbing

Respective portions of the hand line 108 are securely fastened within an opening 118A of each respective coupler 118. Meanwhile, the horn line 110 freely passes through the dedicated opening 118B of each coupler 118. Such embodiments provide for independent manipulation (i.e., pulling) of the hand line 108 relative to the horn line 110 such as during a retrieval of the cast net from the water. These embodiments also provide for independent manipulation (i.e., pulling) of the horn line 110 relative to the hand line 108, for removal of the cast net body 102, or freeing of the cast net body 102, from an underwater obstruction when retrieving the cast net body 102 from the water.

FIG. 1H illustrates a detailed view of the cast net retrieving device 100 with the horn line and coupler assembly. One end of the horn line 110 is attached to the hand line 108. Preferably, each coupler 118 is spaced 19 inches apart, providing a more comfortable grip when raising the cast net body 102.

The horn line 110 extends downward a predetermined distance towards the net webbing 104, forming an intermediate loop before extending upwards towards the central horn 106. The predetermined downward extension of the horn line 110 is approximately half the radius (R in FIG. 1F) of the cast net body 102. For example, if the cast net body 102 has a radius (R in FIG. 1F) of 6 feet, then the intermediate loop may also measure 6 feet. This 6-foot intermediate loop does not affect the normal functions of the cast net body 102.

The hand line 108 is attached to the horn line 110 approximately one foot below the elastic wristband 130, where the elastic wristband 130 is connected to the proximal end 108a of the hand line 108.

FIG. 1I illustrates an example operation of the cast net retrieving device 100 with the horn line 110 and coupler 118 assembly. Typically, when a user finds there to be too much tension on the hand line 108, that is indicative that the net webbing 104 and lead line 102C of the cast net body 102 have become snagged, obstructed or stuck on an object underwater. Applying additional upward pulling force (Arrow U) on the hand line 108 to retrieve the cast net 102 often results in breakage of one of more of the two braille lines 102A. If the cast net body 102 is not free from the snag or obstruction and the user continues to exert such upward pulling force, the braille lines 102C may begin to tear completely off the lead line 102C, leaving the lead line 102C in the water.

Therefore, as the hand line 108 is securely fastened to the designated opening 118A on each coupler 118, the horn line 110 freely passes through the dedicated opening 118B of each coupler 118. This design allows for independent manipulation of the hand line 108 for retrieval, and the horn line 110 for net deployment.

During retrieval, the user begins pulling the hand line 108. This creates tension that travels through the entire cast net body 102. As the hand line 108 is pulled, the cast net body 102 starts to rise from the bottom. Ideally, the net is lifted straight up with minimal tilting, ensuring a centered retrieval. The pull on the hand line 108 translates to tightening of the braille lines 102A. The braille lines 102A, previously relaxed, become taut as they bear the weight of the net and any captured fish or stone. Therefore, using the proposed cast net retrieving device 100, the user is required to pull the horn line 110, causing the cast net body 102 to raise and thereby release the braille lines 102A from the snag.

FIG. 1J illustrates an exemplary elevational view of a coupler 118 connecting the hand line 108 and the horn line 110. A portion of the hand line 110 is fixed inside of the coupler 118 at 118A, as shown in FIG. 1K. Referring to FIG. 1K, the coupler 118 also defines an opening 118B that allows the horn line 110 to operatively slide through it.

FIG. 1K illustrates a partial cut-a-way view of the coupler 118. As depicted, the coupler 118 is preferably designed in a football shape. The coupler 118 has two adjacent openings 118A and 118B. The opening 118A firmly grasps a portion of the hand line 108, preventing the hand line 108 from passing through the opening 118A.

In a preferred embodiment, opening 118A comprises a plurality of internal teeth 119 designed to hold the hand line 108 tightly, by penetrating into respective portions of the hand line 108, as shown in FIG. 1K, preventing any movement through the opening 118A of the respective portion of the hand line 108 that is disposed within the opening 118A. Opening 118B of the coupler 118 preferably includes a smooth internal wall designed to receive the horn line 110 and allow the horn line 110 to pass or move freely through the opening 118B, bidirectionally, as illustrated with Arrow D.

Referring to FIGS. 1G and 1E, when at least one braille line 102A of the plurality of braille lines 102A and the lead line 102C of the cast net body 102 are snagged on an underwater obstruction, such as a stone or broken piling, it can be appreciated by those of ordinary skill in the art that when the disclosed horn line 110 is pulled upward (Arrow U) by a user, that pulling action of the horn line 110 and connected central horn 106 effects an upward pulling upon the central horn 106, which is connected to the net webbing 104, which then imparts tension in the net webbing 104 thereby alleviating and relaxing the tension in the braille lines 102C. Such alleviated tension, or relaxation of the tension, in the braille lines 102C facilitates a loosening up of the otherwise basket hitch that is otherwise formed around the underwater obstruction (by the braille lines 102A and lead line 102C), such that the upwards pulling (Arrow U) of the horn line 108 and connected central horn 106 pulls upward upon the connected net webbing 104 thereby releasing or freeing up the cast net body 102 from the underwater obstruction. In other words, embodiments of the invention enable the user to slide the cast net body 102, including net webbing 104 and lead line 102C, off the underwater obstruction, without breaking the braille lines 102A and without the user needing to enter the water himself or herself.

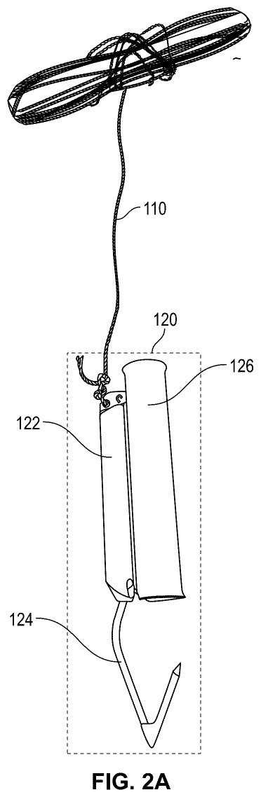

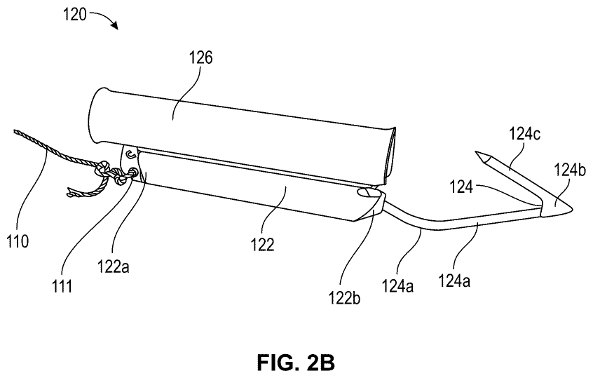

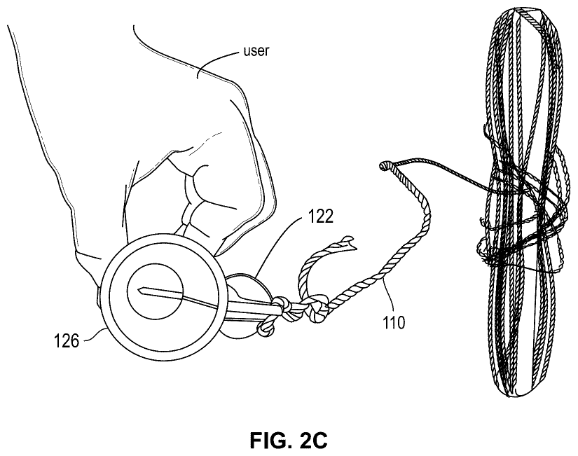

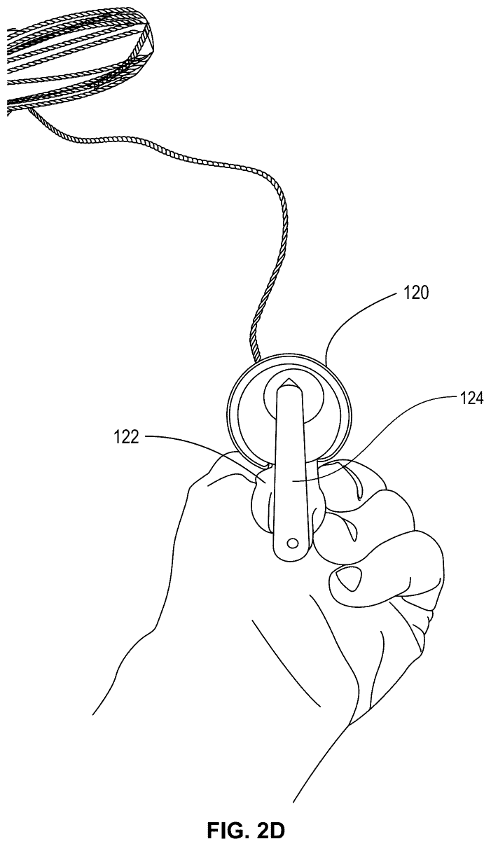

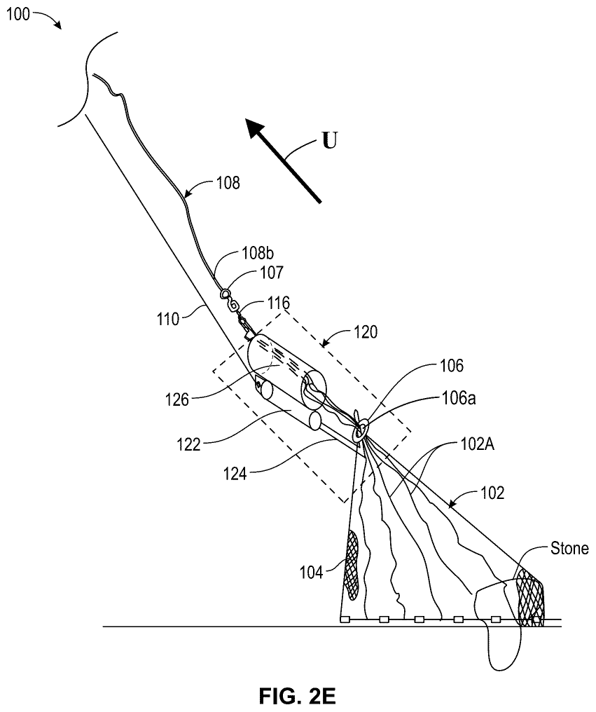

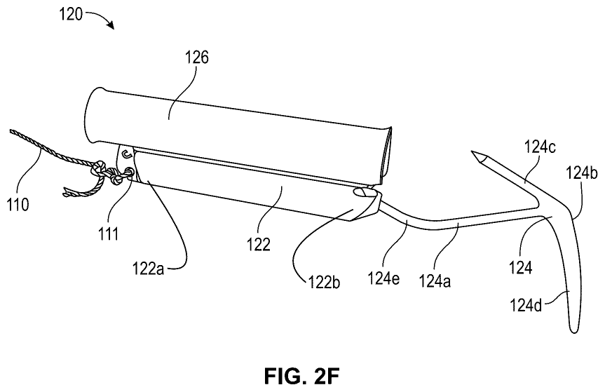

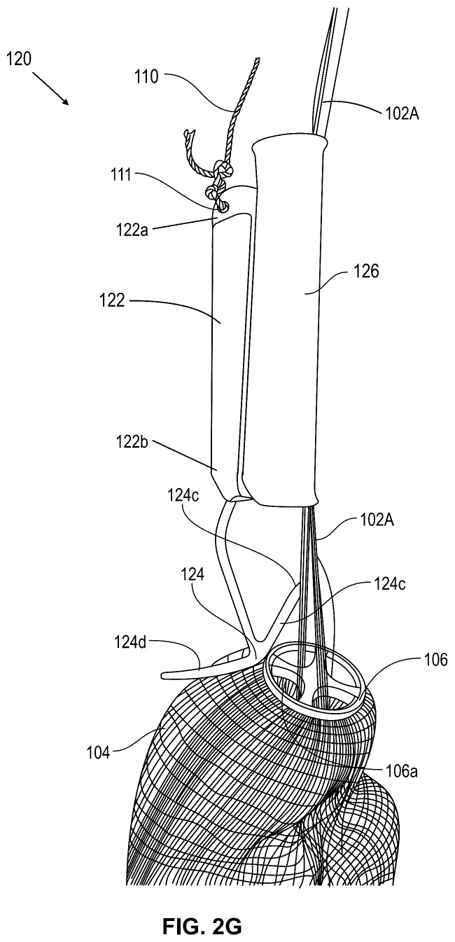

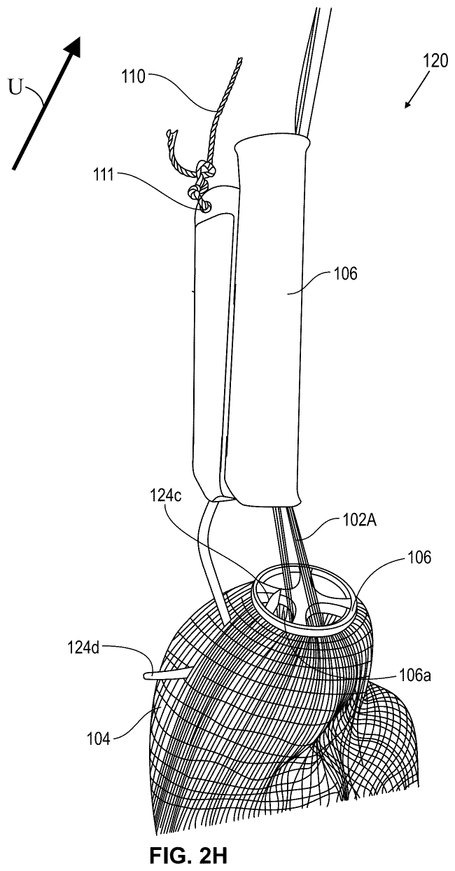

Referring to FIGS. 2A to 2E, a cast net retrieval device 100 is disclosed comprising a horn hook 120.

In one embodiment, the horn hook 120 includes an elongated member 122 having a first end 122a opposite a second end 122b, as illustrated in FIG. 2A-2B. The first end 122a defines an eyelet 111, to which a horn line 110 is connected, and the second end 122b comprises a hook 124.

The horn hook 120 also includes a hollow member 126 that is formed adjacent to the elongated member 122. In one embodiment, the hollow member 126 is welded to the elongated member 122. In another embodiment, the hollow member 126 is integrally formed with the elongated member 122 as a unitary construction.

The hollow member 126 is adapted to slidingly receive therethrough a hand line 108 of a cast net, as illustrated in FIGS. 2E, 2G, and 2H. As illustrated in FIG. 2E, the horn hook 120 can slide down a hand line 108 and respective braille lines 102A of a cast net, because the hand line 108 and respective braille lines 102A pass through the hollow member 126 of the horn hook 120. As such, the hook 124 of the horn hook 120 is adapted to slidingly engage and removably connect to the central horn 106 of the cast net body 102, as illustrated in FIGS. FIGS. 2E, 2G, and 2H. The horn hook 120 is slidingly engaging the central horn 106 of a cast net in FIG. 2G, and the horn hook 120 is removably connecting to the central horn 106 of the cast net in FIG. 2H.

In other words, upon a deployment of the horn hook 120 along the hand line 108, the hand line 108 and respectively connected braille lines 102C are allowed to pass through the hollow member 126 of the horn hook 120, and the hook 124 of the horn hook 120 can engage and connect to the central horn 106 of the cast net body 102. FIG. 2G provides an exemplary perspective view of the horn hook 120 engaging the central horn 106 and its net webbing 104. FIG. 2H provides an exemplary perspective view of the removable connection of the horn hook 120 to the central horn 106 of the cast net.

Because the horn line 110 is connected to the eyelet 111 of the first end 122a of the elongated member 122 of the horn hook 120, the horn hook 120 is configured to be pulled upwardly by a user, which, when the horn hook 120 is connected to the central horn of a cast net body 102, such upward pulling of the horn line 110 by the user thereby imparts a respective upward pulling force (Arrow U in FIG. 2E and FIG. 2H) upon the central horn 106 of the cast net.

As can be seen in FIG. 2E, the horn line 110 is adapted to impart an uplifting force (Arrow U in FIG. 2E and FIG. 2H) upon the central horn 106 and to the net webbing 104 fixed to the central horn 1067, upon a horn line pulling by the user in the direction of Arrow U when the hook 124 of the horn hook 120 is removably connected to the central horn 106. As detailed above, this uplifting force imparted upon the central horn 106 alleviates tension in the braille lines 102A, which facilitates retrieval of the cast net when the weighted lead line 102C and/or net webbing 104 is snagged upon an underwater obstruction.

Referring to FIG. 2F-2H, in a preferred embodiment, the hook 124 of the horn hook 120 comprises a hook shank 124a, a hook bend 124b, a hook catch 124c, and a net deflector 124d. The hook bend 124b is disposed at a distal end of the hook shank 124a. The hook catch 124c extends from the hook bend 124b at an acute angle to the hook shank 124a. The net deflector 124d extends from the hook bend 124b at an obtuse angle to the hook shank 124a, as illustrated in FIG. 2F.

As exemplified in FIG. 2G, the net deflector 124d is configured to deflect the net webbing 104 upon a deployment of the horn hook 120 down the hand line 108, to facilitate engagement of the hook catch 124c with the central horn 106 of the cast net body 104. As can be seen, the net deflector 124c prevents the hook bend 124b from getting caught in the net webbing 104. If the hook bend 124b gets caught in the net webbing 104, that can sometimes prevent the hook catch 124c from reaching far down enough to get underneath the central horn 106; and thus the net deflector helps to prevent the hook bend 124b from getting caught in the net webbing 104. In other words, the net deflector 124d deflects the net webbing out of the way when the horn hook 120 is deployed. As such, the hook deflector 124d aids the hook 124 in successfully engaging the central horn 106, because the hook catch 124c can reach far down enough to get underneath the central horn 106, such that an upward pulling of the horn hook 120 would force the hook catch 124c to engage and removably connect to the central horn 106 of the cast net body 102.

In a preferred embodiment, the hollow member 126 of the horn hook 120 comprises a cylindrical body, as illustrated in FIG. 2B-2G, for example, having a round cross-section. In another embodiment, the hollow member 126 comprises a hollow body having a square cross-section or a rectangular cross-section. The hollow member 126 preferably has a length of 8 inches and a diameter of 1.5 inches.

The elongated member 122 of the horn hook 120 preferably comprises an elongated weighted body, and the weighted body member 122 preferably has a weight of 2 lbs. In a preferred embodiment, a length of the elongated member 122 is 6.5 inches. In a preferred embodiment, the elongated weighted body member 122 comprises a cylindrical body having a diameter of 1 inch. It is important for the elongated member 122 to have a weight that exceeds a weight of the hollow member 126, because the heavier weight of the elongated member 122 helps to keep the connected hook 124 of the horn hook 120 positioned downwardly when the horn hook 120 is deployed down a hand line 108 toward a central horn 106, analogous to how a weighted keel of a vessel helps to keep a rudder of a vessel positioned downward in water.

Referring to FIG. 2E, when at least one braille line 102A of the plurality of braille lines 102A and the lead line 102C of the cast net body 102 are snagged on an underwater obstruction, such as a stone or broken piling, it can be appreciated by those of ordinary skill in the art that when the disclosed horn line 110 is pulled upward (Arrow U) by a user, that pulling action of the horn line 110 and connected horn hook 124 effects an upward pulling upon the central horn 106, which is connected to the net webbing 104, which then imparts tension in the net webbing 104 thereby alleviating and relaxing the tension in the braille lines 102C. Such alleviated tension, or relaxation of the tension, in the braille lines 102C facilitates a loosening up of the otherwise basket hitch that is otherwise formed around the underwater obstruction (by the braille lines 102A and lead line 102C), such that the upwards pulling (Arrow U) of the horn line 108 and horn hook 124, which is removably connected to the central horn 106, pulls upward upon the central horn 106 and connected net webbing 104 thereby releasing or freeing up the cast net body 102 from the underwater obstruction. In other words, embodiments of the invention enable the user to slide the cast net body 102, including net webbing 104 and lead line 102C, off the underwater obstruction, without breaking the braille lines 102A and without the user needing to enter the water himself or herself.

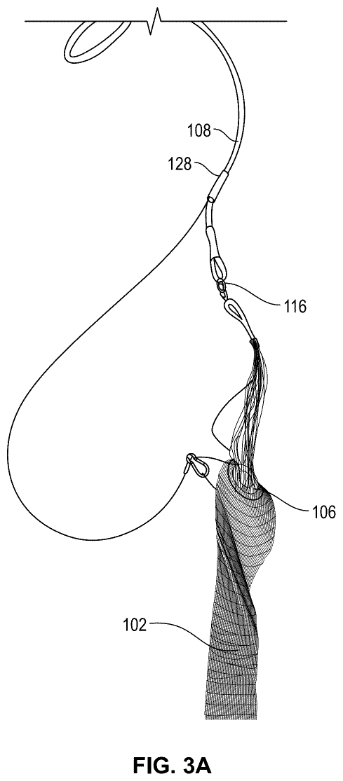

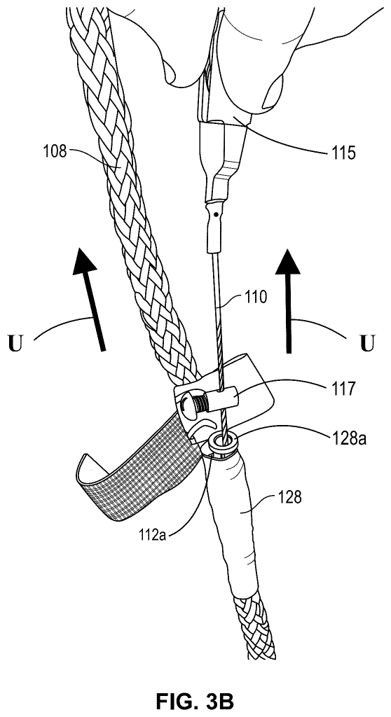

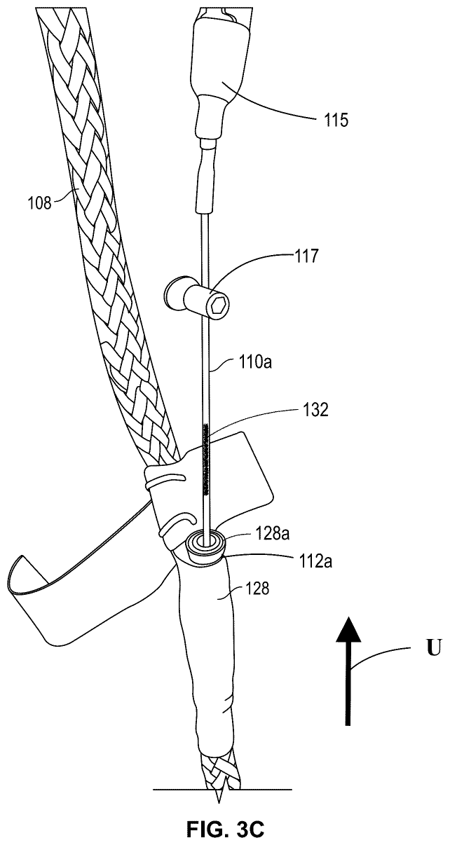

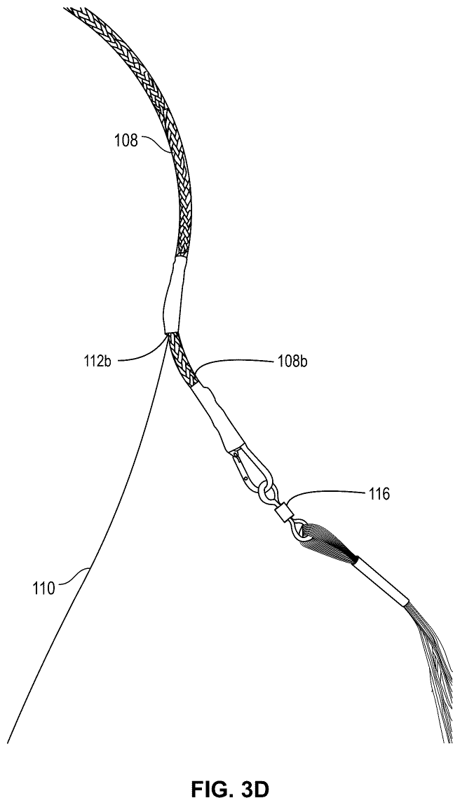

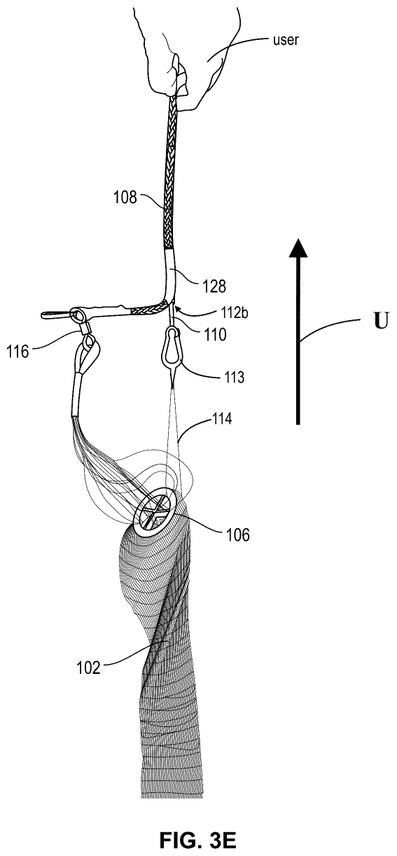

Referring to FIG. 3A-3E, a cast net retrieving device 100 is disclosed comprising a hand line 108 including a tube joint 128 embedded within the hand line 108, and the cast net retrieving device 100 includes a horn line 110 extending through the tube joint 128. In a preferred embodiment, the hand line 108 defines a channel within which the tube joint 128 is disposed, through a majority of a length of the hand line 108, as further detailed below.

In one embodiment, the cast net retrieving device 100 includes a cast net body 102 having a central horn 106 connected to the net webbing 104. The net webbing 104 has a weighted lead line 102C at a distal end thereof, and the cast net body 102 is adapted to be thrown by a user into a water body for fishing.

The hand line 108 has a proximal end 108a opposite a distal end 108b. The proximal end 108a of the hand line 108 is illustrated in FIG. 3B-3C. The distal end 108b of the hand line 108 is illustrated in FIG. 3A and FIG. 3D.

As illustrated in FIG. 3D, in a preferred embodiment, the distal end 108b of the hand line 108 is removably connected to a swivel 116 of the cast net body 102. The swivel 116 is operatively connected to a plurality of braille lines 102A that slidably extend through a central horn 106 of the cast net body 102. The plurality of braille lines 102A have respective distal ends connected to the weighted lead line 102C.

As illustrated in FIG. 3A-3D, in a preferred embodiment, the cast net retrieving device 100 includes the tube joint 128 that is embedded within the hand line 108. The tube joint 128 has a proximal end 128a positioned at a first aperture 112a of the hand line 108, and the first aperture 112a is defined by a proximal end 108a of the hand line 108, as shown in FIG. 3B and FIG. 3C.

The tube joint 128 has a distal end 128b positioned at a second aperture 112b of the hand line 108, and the second aperture 112b of the hand line 108 is defined by a distal end 108b of the hand line 108, as shown in FIG. 3A and FIG. 3D.

In a preferred embodiment, the tube joint 128 extends from the proximal end 108a of the hand line 108, as shown in FIG. 3B-3C, to the distal end of the hand line 108, as shown in FIG. 3A, FIG. 3D and FIG. 3E.

The horn line 110 has a proximal end 110a opposite a distal end 110b. The horn line 110 is operatively disposed within the tube joint 128, as exemplified in FIGS. 3B-3C The proximal end 110a of the horn line 110 extends outwardly from the tube joint 128 at the first aperture 112a. The distal end 110b of the horn line 110 extends outward of the tube joint 128 at the second aperture 112b, as illustrated in FIGS. 3D-3E and the distal end 110b of the horn line can removably connect to the central horn 106 of the cast net body 102.

In one embodiment, the horn line 110 is connected to the central horn 106 through a basket hitch connector 114, as illustrated in FIG. 3E. The basket hitch connector 114 forms a loop around the central horn 106, and ends of the basket hitch connector 114 are connected to a horn line clasp 113 of the horn line 110.

In one embodiment, a length of the horn line 110 is at least 1 foot greater than a length of the hand line 108. In a preferred embodiment, a length of the horn line 110 is greater than a length of the hand line 108 by a length equal to a radius (R in FIG. 1F) of the net webbing of the cast net body. In a preferred embodiment, a preferred length of the horn line 110 is longer than a length of the hand line 108 by a length that is equal to (or longer than) a length of a radius (R) of the cast net, as illustrated in FIG. 1F. For example, a 6-foot cast net can a radius (R) of 6 feet, which is the distance from the central horn 106 to the lead line 102C. When opened, the net will unfold into a circle that is 12 feet across in diameter, which is twice the radius (R). Thus, in this example, in a preferred embodiment, a length of the horn line 110 is longer than a length of the hand line 108 by a length that is equal to 6 feet, because that is the length of the radius of the cast net, in this illustrative example.

Referring to FIG. 3C, in a preferred embodiment, the horn line 110 comprises a colored marker near a proximal end 110a thereof. The colored marker is indicative of a length of horn line 110 sufficiently pulled out of the first aperture 112a adapted to indicate alleviated tension in the braille lines 102A.

FIG. 3D provides an exemplary view of the distal end 110b of the horn line extending outwardly from the second aperture 112b of the hand line 108. The horn line 110 is extended outwardly from the tube joint 128 at the distal end 108b of the hand line 108.

In a preferred embodiment, the horn line 110 is a flexible steel cable. In other embodiments, the horn line 110 is fabricated of a flexible material selected from the group consisting of steel cable, braided nylon, and synthetic fiber, and combinations thereof. For a synthetic fiber, the horn line 110 is preferably fabricated of polypropylene, nylon, polyesters (e.g. PET, LCP, Vectran), polyethylene (e.g., Dyneema® and Spectra®), Aramids (e.g., Twaron®, Technora®, and Kevlar®) and/or acrylics (e.g., Dralon®).

A handle 115 is preferably connected to the proximal end 110a of the horn line 110, as illustrated in FIG. 3B and FIG. 3C. The handle 115 is preferably sized and configured to be grasped by a hand of the user.

In one embodiment, a marker indicator 132 is included near the distal end 110a of the horn line 110, as shown in FIG. 3C. The marker indicator 132 provides the user with a visual point of reference, such that the user can see how much length of horn line 110 has been pulled by the user, outward of the tube joint and respective hand line 108, as shown in FIG. 3C. For example, when the user pulls the horn line 110 sufficiently out of the distal end 128a of the tube joint 128, the marker indicator 132 is then visually revealed to the user, as illustrated in FIG. 3C (because it is located on a surface of a portion of the horn line 110 that was previously embedded inside of the tube joint 128); and the marker indicator 132 visually indicates to the user that a sufficient length of horn line 110 has been pulled such that the braille lines 102A are now at a relaxed state because adequate tension has been alleviated from the braille lines 102A as a result of the user's pulling sufficiently on the horn line 110.

In one embodiment, a clamp 117 is operatively connected near the proximal end 110a of the horn line 110; and the clamp 117 is preferably a spring-loaded clamp 117 that is operatively connected near the proximal end 110a of the horn line 110, as illustrated in FIG. 3B and FIG. 3C. As shown, the horn line 110 is threaded through the spring-loaded clamp 117. The spring-loaded clamp 117 is moveable from a clamped engagement upon the horn line 110 to an unclamped engagement upon the horn line 110. In the unclamped engagement, the horn line 110 is able to slide through the spring-loaded clamp 117. In the clamped engagement, the horn line 110 is not able to move through the spring-loaded clamp 117, because the spring-loaded clamp 117 is then clamped onto the horn line 110, gripping it in a firm engagement.

In a preferred embodiment, when the spring-loaded clamp 117 is positioned in the clamped engagement of the horn line 100, the horn line 110 can be pulled by the user in tandem with the hand line 108, because the clamp 117 cannot pass through the proximal end 128a of the tube joint 128. As such, the horn line 110 is pullable upon a pulling of the hand line 108 by the user.

The horn line 110 is adapted to exert an uplifting force upon the central horn 106 and the connected net webbing 104, upon a horn line pulling by the user through the tube joint 128 and respective hand line 108. The uplifting force is configured to alleviate tension in the braille lines when the weighted lead line and/or net webbing is snagged upon an underwater obstruction.

FIG. 3B refers to a schematic view of a pulling action (Arrow U) of the horn line 110 upwardly through the tube joint 128, as it is pulled upwardly by a user. In a similar nature to the description above regarding the effect of an upward pulling upon a central horn 106 releasing a snagged cast net boy 102 from an underwear obstruction, in this embodiment, the horn line 108 is pulled by a user through the tube joint 128 that is embedded within the hand line 108, to exert an upward pulling force upon the central horn 106 to which the distal end 108b of the horn line 108 is connected, in order to free up or release a cast net body 102 from an underwater obstruction.

Because the horn line 110 can move freely inside of the tube joint 128, the horn line 110 provides the user with control over the central horn 106, because the horn line 110 is adapted to pull upwardly upon the central horn 106 to which the horn line 110 is connected, as illustrated in FIG. 3E. The upward pulling on the central horn 106 by the horn line 110 relaxes tension in the braille lines 102A (as described above). As noted above, the distal end 110b of the horn line 110 is preferably connected to the central horn 106 with a basket hitch connector, as illustrated in FIG. 3E, which exemplifies the upward pulling force (Arrow U) of the horn line 110 acting upon the central horn 106 and respective net webbing 104 of the cast net body 102. As can be appreciated from this disclosure, the upward pulling force upon the disclosed horn line 110 and connected central horn 106 imparts an upward pulling force upon the net webbing 104 that is connected to the central horn 106, thereby releasing the net webbing 106 and lead line 102C from the underwater obstruction. In other words, the net webbing 104 and lead line 102C can slide off the underwater obstruction, releasing the cast net body 102 form the snag, without breaking the braille lines 102A and without the user needing to enter the water, through embodiments of the disclosed invention.

FIG. 3C refers to an exemplary view of the upward pulling action (Arrow U) of the horn line 110 through the embedded tube joint 128 by the user, where the horn line 110 is extended from the tube joint 128 when pulled by the user.

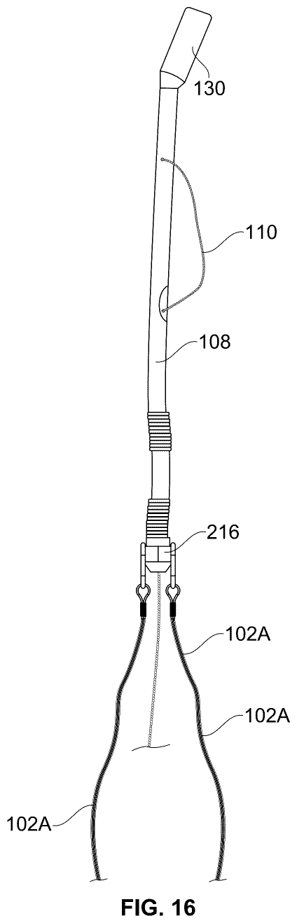

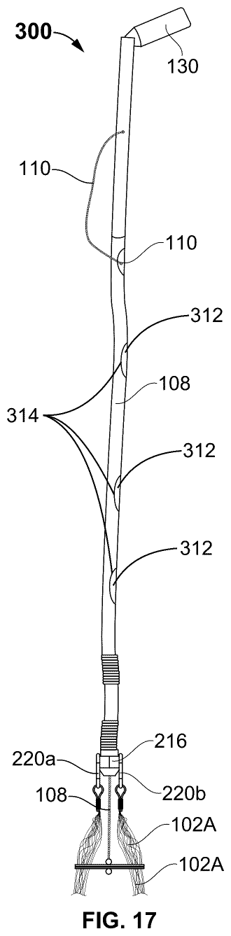

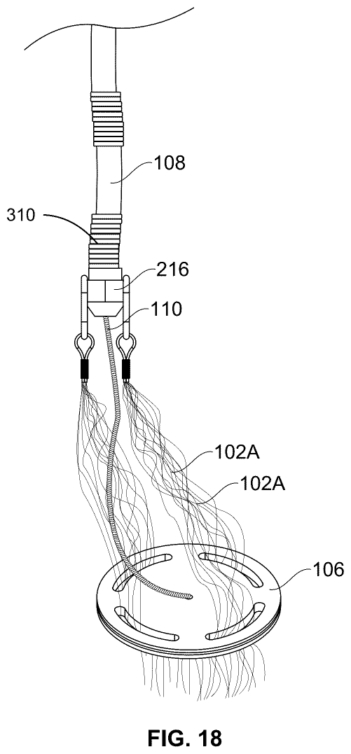

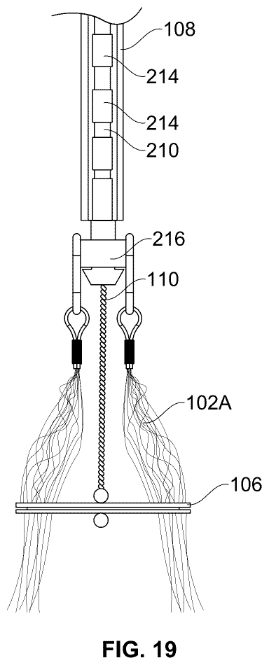

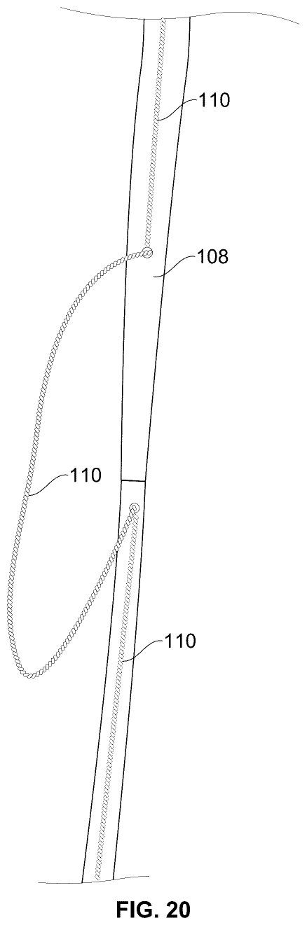

Referring initially to FIG. 16-25, an embedded horn line cast net retrieval device 300 comprises a cast net body 102 having a net webbing 104 terminating at a weighted lead line 102C disposed at a distal end of the net webbing 104. A central horn 106 is affixed at the upper portion of the cast net body 102. The central horn 106 defines a central retention aperture 202 for operative connection with a horn line 110 as described further herein. In operation, the cast net body 102 is adapted to be thrown outwardly by a user into a water body for fishing.

In operation, when the cast net body 102 is cast outwardly, the weighted lead line 102C ensures radial expansion of the net webbing 104 across the water surface, thereby maximizing the area of coverage for entrapping fish.

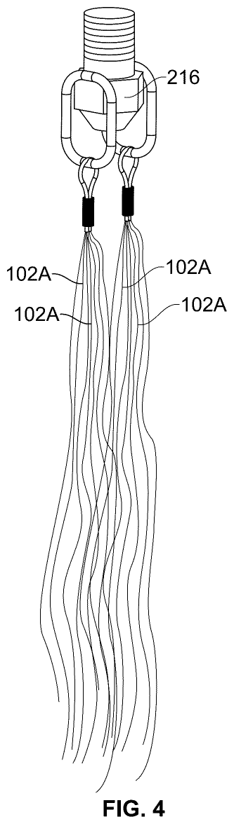

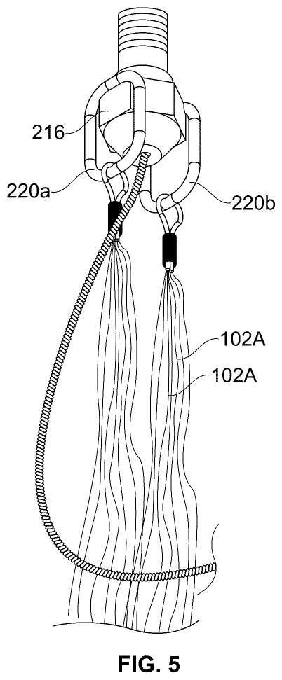

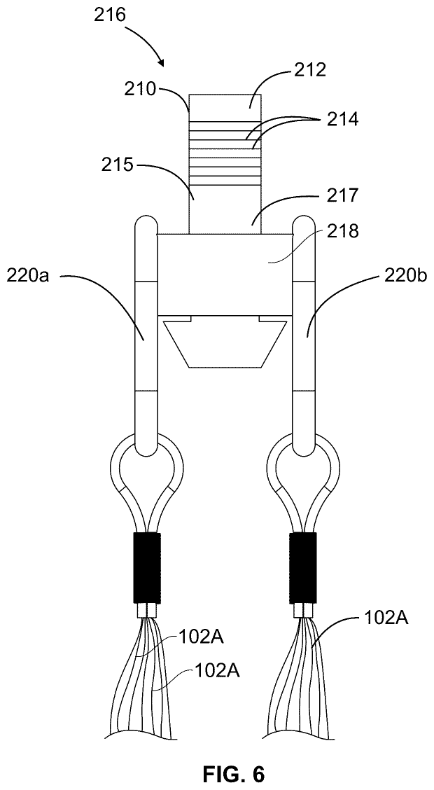

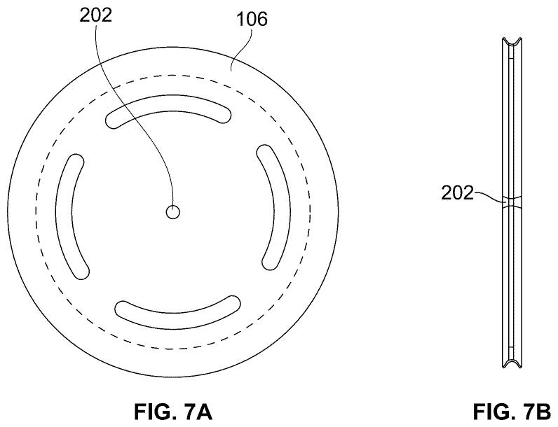

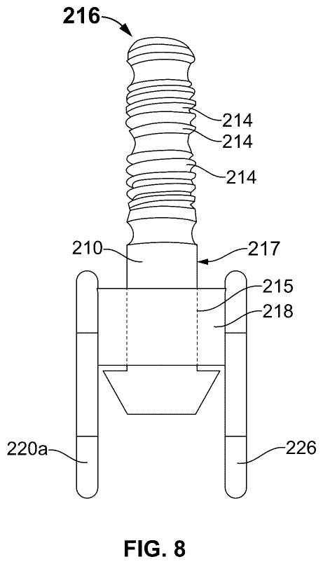

As shown in FIG. 4-6, 8, 16-19, and 21-24, the embedded horn line cast net retrieval device 300 has swivel connector 216 (FIGS. 4-6 and 8) that includes a pair of linkage arms 220a, 220b. The pair of linkage arms 220a, 220b of the swivel connector 216 maintain the orientation and separation of the braille lines 102A during both the casting and retrieval phases, thereby preventing entanglement of the braille lines 102A with the horn line 110 and ensuring smooth contraction of the net webbing 104 around captured fish.

A hand line 108 extends outwardly from the cast net body 102. The hand line 108 includes a proximal end 108a adapted for grasping by the user and a distal end 108b connected to the swivel connector 216. Unlike arrangements employing external couplers, the hand line 108 of the present embodiment defines an inner longitudinal passageway 306 extending substantially along its length. The hand line 108 further comprises a proximal portion 302 opposite a distal portion 304.

A first exit aperture 308 is disposed at the proximal portion 302 of the hand line 108. The horn line 110 extends outwardly through the first exit aperture 308, permitting the user to selectively grasp and pull the horn line 110 independent of the hand line 108. The proximal end 110a of the horn line 110 is fixed to the proximal end 108a of the hand line 108, ensuring that tension applied by the user is transmitted through the hand line 108 for reliable handling.

The horn line 110 extends through the inner longitudinal passageway 306 of the hand line 108, continues through the hollow cylindrical rod 210 of the swivel connector 216, and terminates with its distal end 110b fixed to the central retention aperture 202 of the central horn 106. In this manner, the horn line 110 is operatively embedded within the hand line 108, thereby protecting it from external abrasion and entanglement during casting and retrieval operations.

The swivel connector 216 is disposed at the distal end 108b of the hand line 108. The swivel connector 216 comprises a hollow cylindrical rod 210 having a top section 212, preferably formed with circumferential ridges 214, and a lower section 215 having a smooth outer surface 217. An outer ring coupler 218 pivotally engages the lower section 215, thereby permitting relative rotation of the cast net body 102 during retrieval. The outer ring coupler 218 includes an opposing pair of linkage arms 220a, 220b, each operatively connected to a respective set of braille lines 102A slidably extending through the central horn 106 and terminating at distal ends connected to the weighted lead line 102C.

In certain embodiments, a compression ring 310 is disposed around the distal portion 304 of the hand line 108, encircling the interface between the distal end 108b and the top section 212 of the cylindrical rod 210. The compression ring 310 provides mechanical reinforcement, ensuring the secure retention of the distal end 108b of the hand line 108 against the ridges 214 of the swivel connector 216. In a preferred embodiment, the ridges 214 formed on the top section 212 are preferably circumferential serrations spaced 1 millimeter apart, enhancing grip for assembly and resisting slippage of the hand line 108 (relative to the hollow cylindrical rod 210) during repeated casting cycles. In other words, in such embodiment, the ridges 214 of the hollow cylindrical rod 210 help ensure that the distal end of the hand line 108 remains fixed to the hollow cylindrical rod 210 of the swivel connector 216.

Within the inner longitudinal passageway 306, a plurality of intermediate collars 312 are embedded at spaced intervals. The intermediate collars 312 are preferably formed of low-friction material, such as PTFE or acetal resin, to reduce wear and allow smooth sliding of the horn line 110 therethrough. The collars 312 maintain the alignment of the horn line 110 within the passageway 306 and prevent lateral deflection that could otherwise lead to abrasion of the hand line 108. In addition, the intermediate collars 312 also provide for improved gripping surfaces along the hand line 108 for a user, who is handling the hand line 108.

A plurality of lateral access slots 314 are defined by the wall of the hand line 108, each lateral access slot 314 being aligned with a respective intermediate collar 312. The lateral access slots 314 expose localized portions of the horn line 110, enabling the user to grasp and pull the horn line 110 at multiple points along the length of the hand line 108. This arrangement allows selective application of tension, providing improved control over the horn line 108 and respective the central horn 106 and net webbing 104 during retrieval.

Referring to FIG. 16-19, 21, 23, and 24, in some embodiments, the horn line 110 further comprises a horn line stop 222 fixed to the horn line 110 and disposed within the hand line 108 above the hollow cylindrical rod 210 of the swivel connector 216. The horn line stop 222 has an outer diameter greater than the passage diameter of the hollow cylindrical rod 210, thereby restricting axial translation of the horn line 110 beyond a predetermined limit.

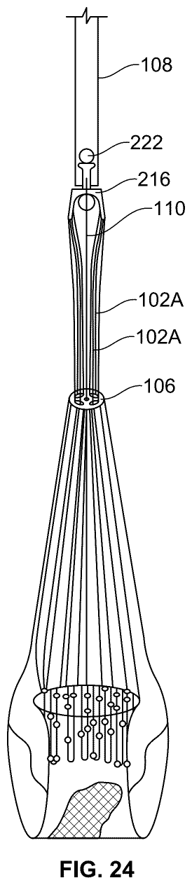

When the horn line stop 222 abuts the top of the cylindrical rod 210, downward travel of the horn line 110 is arrested, forming the bag net formation (FIG. 24) during cast net retrieval operations by a fisherman user.

The horn line stop 222 may be clamped onto the horn line 110 or integrally molded therewith. In alternative embodiments, the horn line stop 222 is formed as a spherical or cylindrical body configured to pass through intermediate collars 312 of larger diameter while being restricted at the cylindrical rod 210. This restriction of axial movement enables the horn line 110 to maintain the central horn 106 in an elevated position relative to the weighted lead line 102C, facilitating the formation of a bag net within the net webbing 104.

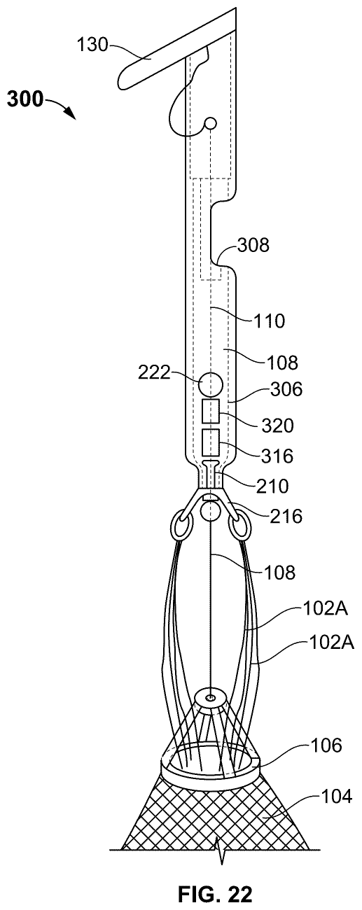

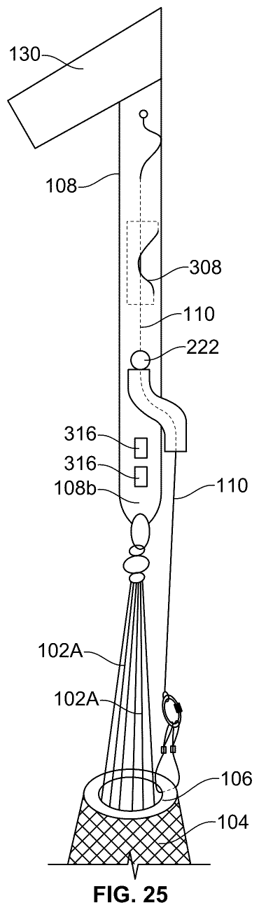

As illustrated in FIGS. 22 and 25, in further embodiments, at least one weight 316 slidably engages the horn line 110 within the passageway 306 of the hand line 108, disposed above the hollow cylindrical rod 210 of the swivel connector 216. The weight 316 assists in maintaining tension in the horn line 110 during submersion, reducing slack and improving retrieval efficiency.

In yet another embodiment, the horn line 110 preferably includes a plurality of color-coded segments 318 (i.e., colored markers) (FIG. 20) positioned near the proximal end 110a of the horn line 110. The plurality of markers 318 provide a visual indication to the user (at all apertures/lateral access slots 314) when a sufficient length of horn line 110 has been withdrawn through the first exit aperture 308 (or through the respective upper other apertures/access lateral slots 314) to alleviate tension in the braille lines 102A. This feature allows the fisherman to rapidly determine the operational state of the cast net during retrieval. This feature allows the fisherman to rapidly determine to determine the position of the horn line 108 in relation to a snag. When a fisherman sees the colored marker 318, he knows that he has released or alleviated the tension in the braille lines 102A.

The central horn 106 may comprise a bottom ring 224 and a plurality of conical arms 226 extending upwardly from the bottom ring 224. The conical arms 226 terminate at upper ends fixed to a top collar 228. The top collar 228 defines the central retention aperture 202 through which the distal end 110b of the horn line 110 is secured. This construction enhances rigidity and balance of the central horn 106 while maintaining a lightweight configuration.

During deployment, the fisherman casts the net body 102 into a water body while grasping the proximal end 108a of the hand line 108. The braille lines 102A extend outwardly with the net webbing 104 and weighted lead line 102C. Upon retrieval, the user may selectively pull either the hand line 108 or the horn line 110 through the first exit aperture 308. Pulling the horn line 110 elevates the central horn 106, removes tension in the braille lines 102A, and allows the weighted lead line 102C to disengage from underwater obstructions. In other words, when the central horn 106 is being held up by the horn line stop 222 engaging the lower coupler 206, the resulting elevated positioning of the central horn 106 redirects the uplifting force by splitting that uplifting force between the handle line 108 and the horn line 110, thereby reducing strain on the braille lines 102A, while simultaneously improving the release characteristics of the catch (e.g., fish, shrimp, etc.) from the cast net body 102. As can appreciated by those of ordinary skill in the art from the disclosure here, the weight of the catch (e.g., fish/shrimp), the net webbing 104, and the weighted lead line 102C is shared 50/50 at that point of uplifting.

When the central horn 106 is elevated by the horn line 110, water passes more efficiently through the net webbing 104, allowing the catch to settle toward the lower portion of the net. This configuration forms a bag net, from which the fisherman can more easily release the catch. The embedded horn line arrangement ensures that the gathering of the weighted lead line 102C remains below the central horn 106 (at a desired distance), thereby preventing the lead line from abutting a bottom of the central horn 106, improving release efficiency.

The embedded horn line system disclosed herein provides several advantages over conventional designs. By housing the horn line 110 within the hand line 108, entanglement of the horn line 110 and hand line 108 is reduced, abrasion is minimized, and the overall handling of the cast net is improved. The combination of intermediate collars 312, lateral slots 314, horn line stop 222, optional weights 316, and colored marker 318 provides fishermen with greater control and adaptability across varying fishing conditions.

In exemplary embodiments, the hand line 108 may be constructed of braided nylon or polyethylene rope having an outer diameter of about 5-10 mm. The inner longitudinal passageway 306 can be formed as a lumen or sheath preferably having a nominal diameter of about 3-8 mm with a surface finish selected to achieve a low coefficient of friction against the horn line 110 while maintaining compressive stability of the hand line 108.

The intermediate collars 312 may be spaced at intervals of about 50-150 mm along the inner longitudinal passageway 306. Suitable materials include PTFE, UHMWPE, acetal, or ceramic bushings, each selected for low friction, corrosion resistance, and wear durability under repetitive wet cycles.

The lateral slots 314 may be elongated, circular, or oval cut-outs sized to expose 6-15 mm of the horn line 110. In certain embodiments, the lateral slots 314 include reinforcing grommets or molded edges to inhibit fraying of the hand line 108 and to provide a tactile edge that assists user grip.

The compression ring 310 may be manufactured from stainless steel, anodized aluminum, or reinforced polymer composites. Outer diameters may range from about 15-30 mm depending on hand line thickness, with an interference or crimp fit against the distal end 108b to resist axial slippage during repeated casting cycles.

In another embodiment, the central horn 106 is a three-dimensional horn (3D horn) comprising a bottom ring 224 and a plurality of conical arms 226 extending upwardly from the bottom ring 224. The conical arms 226 terminate at upper ends fixed to a top collar 228. The top collar 228 defines the central retention aperture 202 through which the horn line 110 is secured. This construction enhances the structural rigidity and balance of the central horn 106 while maintaining a lightweight configuration for efficient casting. In a preferred embodiment, the distal end 110b of the horn line 110 is operatively connected to the central horn 106. The distal end 110b of the horn line 110 is fixed vertically, relative to the central horn, yet the distal end 110b of the horn line 110 remains able to spin (or rotate) freely within the central retention aperture 202 of the central horn 106.

The central horn 106, when implemented as a bottom ring 224 with conical arms 226 and a top collar 228, may present a bottom ring outer diameter of approximately 25-40 mm, with the conical arms 226 projecting at about 45-60 degrees. The top collar 228 defines an aperture sized slightly larger than the horn line 110 to permit secure fastening at the central retention aperture 202.

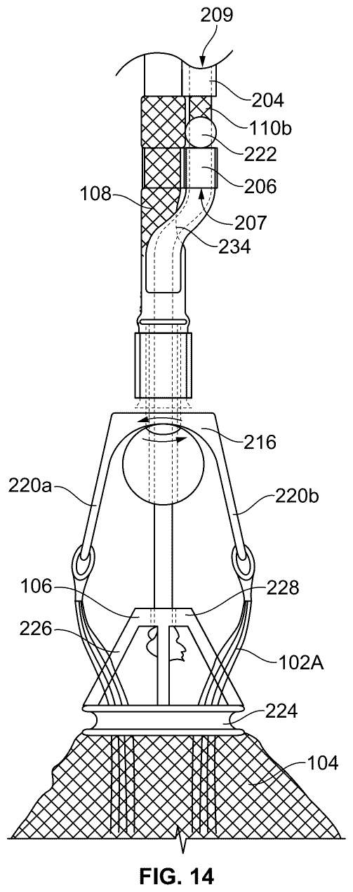

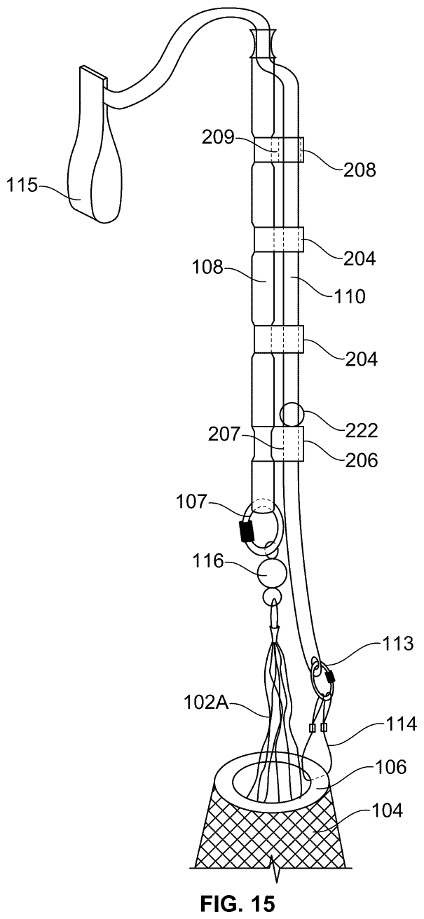

The bottom ring 224 of the central horn 106 is preferably molded from polymeric resin and sized with an outer diameter of approximately 25 millimeters to 40 millimeters. The conical arms 226 preferably extend upwardly at an angle of approximately 45 degrees to 60 degrees, as illustrated, for example in FIG. 14, terminating at the top collar 228. The top collar 228 is preferably circular and defines the central retention aperture 202. The central retention aperture 202 preferably has a diameter slightly larger than a diameter of the horn line 110 to permit rotation (i.e. spinning) of the horn line 110 relative to the central retention aperture 202, while maintaining a fixed securement of the distal end 110b of the horn line 110 vertically. In other words, while the distal end 110b of the horn line can spin freely within the central retention aperture 202 of the central horn 106, an upward pulling of the horn line 110 by a user causes an upward pulling of the central horn 106 and respective cast net webbing 104, at the option of the user.

The horn line 110 may be formed of braided aramid fibers (e.g., Kevlar®), high-tenacity polyester, or UHMWPE, with a breaking strength of about 200-500 pounds. Alternative embodiments may employ monofilament or fluorocarbon where reduced visual signature is desired.

The braille lines 102A are typically thinner than the horn line 110 and may be formed of monofilament nylon having a diameter of approximately 1-3 mm. Each braille line 102A passes through the central horn 106 and distributes retrieval force to the weighted lead line 102C, thereby drawing the net webbing 104 inward during retrieval.

The weighted lead line 102C may comprise a continuous cord carrying metallic sinkers at spaced intervals of about 10-20 cm. Alternative embodiments may utilize molded polymeric sinkers incorporating high-density fillers (e.g., barium sulfate) to reduce environmental impact while maintaining adequate sink rate.

In one embodiment, the top edge of the net webbing 104 is directly sewn into the bottom ring 224 of the central horn 106 to provide a robust mechanical joint. This direct fixation overcomes limitations of conventional cast nets where the top edge is merely tightened around the horn.

In certain embodiments, the braille lines 102A are separated into two distinct groups with the horn line 110 routed between them along at least a portion of the device path. This separation minimizes the likelihood of entanglement between the horn line 110 and the braille lines 102A during both casting and retrieval.

Referring to FIG. 22, in a preferred implementation supporting controlled bag net formation, a proximal coupler 320 is provided within the inner longitudinal passageway 306 adjacent the first exit aperture 308. The proximal coupler 320 is dimensioned to allow sliding motion of the horn line 110 yet provides a proximal limit surface that cooperates with the horn line stop 222 (distal stop) to restrict axial movement of the horn line 110 within the inner longitudinal passageway 306 during cast net deployment and retrieval, thereby promoting formation of the lower bag portion of the net.

The embedded horn line system thus enables controlled positioning of the central horn 106 relative to the weighted lead line 102C. By restricting axial movement at a defined distal limit (e.g., horn line stop 222 abutting the proximal coupler 320), lifting forces are redirected through the horn line 110 and the braille lines 102A together, improving reliability of catch release and reducing stress concentrations within the net webbing 104. As can appreciated by those of ordinary skill in the art from the disclosure here, the weight of the catch (e.g., fish/shrimp), the net webbing 104, and the weighted lead line 102C is shared 50/50 at that point of uplifting.

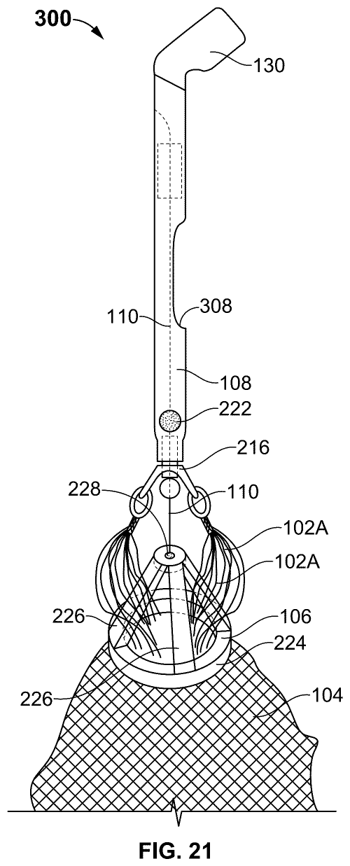

FIG. 21 illustrates an embodiment of the embedded horn line cast net retrieval device 300 having the horn line stop 222, which is configured to abut against the top of the hollow cylindrical rod 210 of the swivel connector 216. FIG. 22 illustrates an embodiment of the embedded horn line cast net retrieval device 300 having the horn line stop 222 and having a proximal coupler 320 and having a weight 316, where the horn line stop 222 is configured to abut against the proximal coupler 320, which is disposed above the weight 316, which is disposed above the hollow cylindrical rod 210 of the swivel connector 216. As can be appreciated from the disclosure herein, certain embodiments of the embedded horn line cast net retrieval device 300 can either include the weight 316 or not include the weight 316. Similarly, certain embodiments of the embedded horn line cast net retrieval device 300 can either include the proximal coupler 320 or not include the proximal coupler 320.

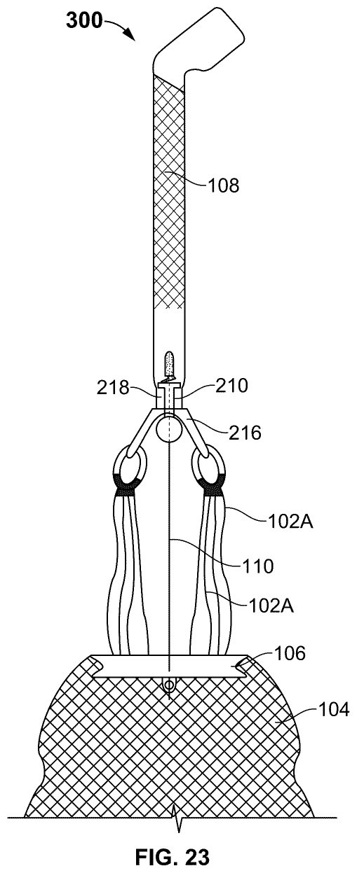

Referring to FIGS. 23-24, in one embodiment, the embedded horn line cast net retrieval device 300 has a horn line 110 having a fixed length, which extends from a horn line stop 222, which is disposed above the hollow cylindrical rod 210 of the swivel connector 216, downwardly to the central horn aperture of the central horn 106. In other words, in such embodiment, there is a fixed length horn line 110 that extends from the central horn retention aperture 202 up to the horn line stop 222 that is located just above the hollow cylindrical rod 210 of the swivel connector 216. In such embodiment, the horn line 110 does not further extend upwardly further into the hand line 108, but instead, the proximal end of the horn line 110 terminates at the horn line stop 222, as illustrated in FIGS. 23-24.

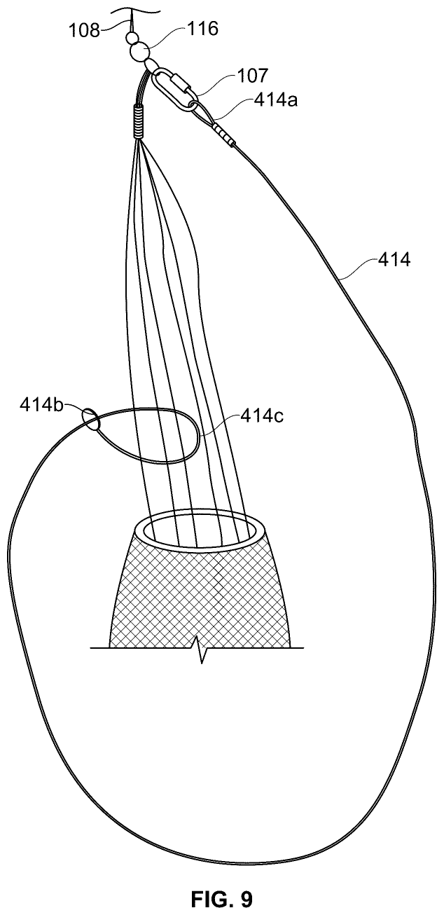

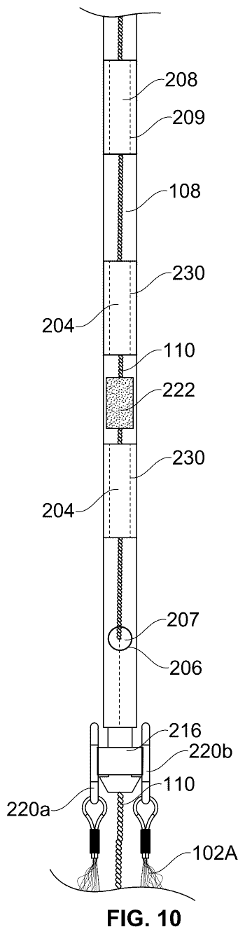

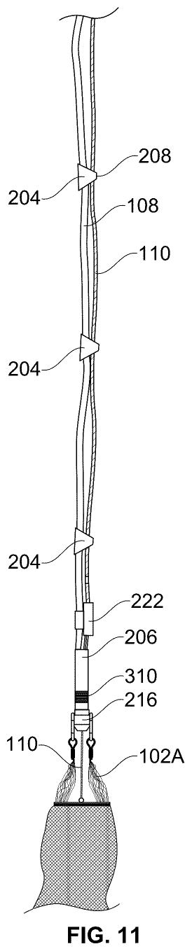

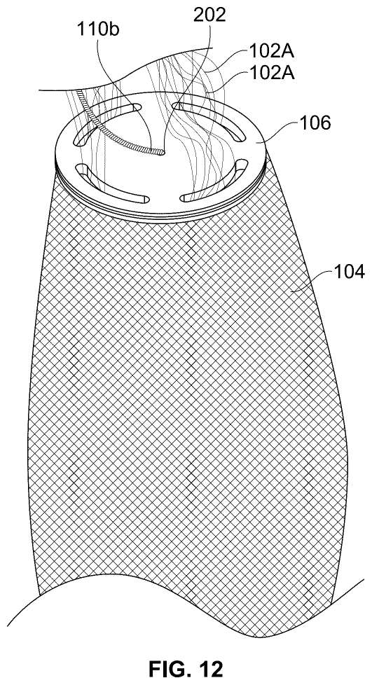

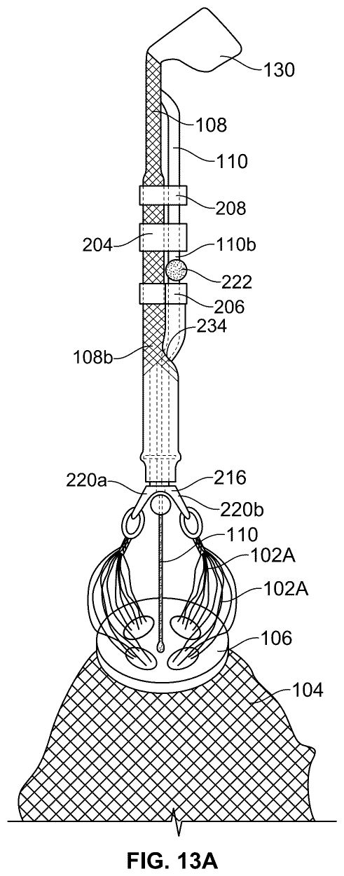

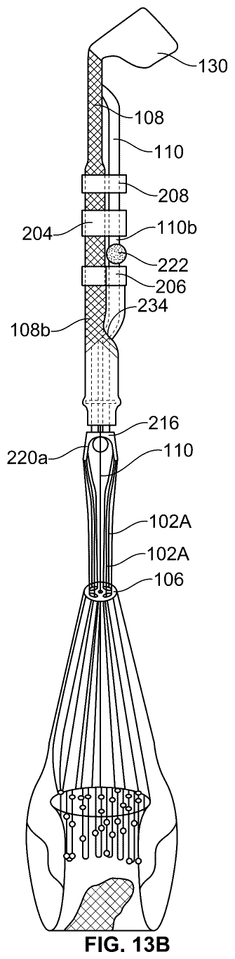

Referring to FIG. 9, there is provided a choker hitch connector 414, which has a proximal end eyelet 414a adapted to connect to either directly to a swivel 116 that is connected to the distal end 108a of the hand line, or directly to a spring-loaded hook/clasp 107 (which directly connects to the swivel 116). The choker hitch connector 414 has a distal end eyelet 414b through which the flexible line of the choker hitch connecter 414 is adapted to extend through, to form a loop 414c, as shown in FIG. 9. As such, the loop 414c is adapted to connect to a central horn 106 of a cast net device, by a user inserting the proximal end eyelet 414a through the central horn 106, then inserting that proximal end eyelet 414a through the distal end eyelet 414b of the choker hitch connector 414 itself, and then pulling the proximal end eyelet 414a upward to connect it to the spring loaded hook/clasp 107 or swivel 116 (as noted above), thereby cinching the choker hitch connector 414 around a portion of the central horn 106.

Through embodiments herein, the choker hitch connector 414 enables a fisherman to connect the choker hitch connector 414 to a distal end of a hand line of a conventional cast net device, and control the relation of the distance between the distal end of the hand line relative to the location of the central horn 106. In. doing so, such embodiments of the invention enable a fisherman to form a bag net formation, analogous to the bag net illustrated in FIG. 24.

As described, these features collectively provide fishermen with greater control over the operation of the cast net retrieval device 200, reduce the risk of snagging and entanglement, and improve the ease with which catches can be released from the net webbing 104.

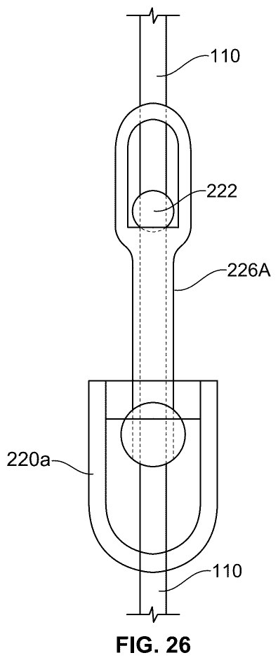

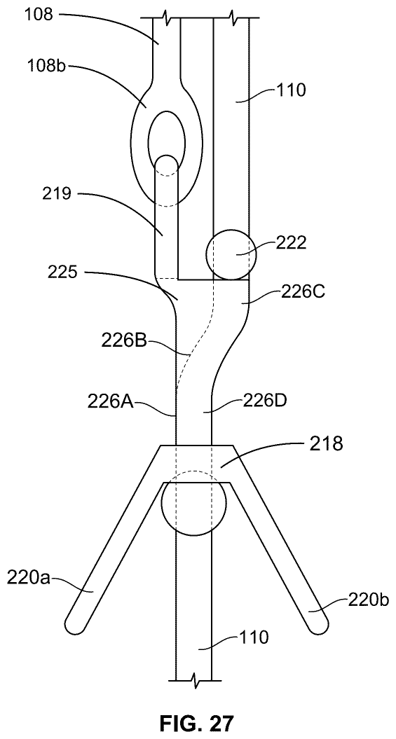

In another embodiment, as illustrated in FIG. 26-27, the embedded horn line cast net retrieval device 300 includes an offset swivel connector 226A as a curved swivel device. The offset swivel connector 226A is provided for use with the cast net retrieval device to reduce torsional loading and improve line alignment during operation. The offset swivel connector 226A retains the general functional configuration of the swivel connector 216, including the lower linkage interface for coupling with the linkage arms (220a, 220b) with the braille lines 102A. The offset swivel connector 226A includes an upper coupling ring 219 for attachment to the distal end 108b of the hand line 108. In a preferred embodiment, the distal end 108b of the hand line 108 is tied to the upper coupling ring 219 of an upper coupling section 225 of the offset swivel connector 226A, as illustrated in FIG. 27.

The offset swivel connector 226A comprises a curved intermediate portion 226B extending between an upper coupling section and a lower linkage interface 226D. The curved intermediate portion 226B defines a bend junction 226C oriented at an acute angle relative to the longitudinal axis of the hand line, preferably between approximately 10 degrees and 25 degrees. This bent configuration repositions the lower linkage interface 226D rearwardly with respect to the horn line axis, thereby establishing a more linear pull path for the horn line 110 through the swivel connector 226A during retrieval.

By offsetting the swivel geometry, the horn line is permitted to travel with reduced friction and minimal twisting relative to the hand line, particularly when the net body is under asymmetric loading conditions caused by partial obstruction or uneven catch weight. The offset swivel connector 226A thereby minimizes rotational binding of the outer ring coupler and promotes smoother lifting of the central horn during horn line tensioning.

The offset swivel connector 226A may be formed from stainless steel, anodized aluminum, or brass, with a corrosion-resistant outer coating. The radius of curvature of the curved intermediate portion 226B may range from approximately 15 millimeters to 40 millimeters, with the selected geometry corresponding to the hand line diameter and overall size of the cast net body. The connector may be machined, cast, or bent from a single piece of rod stock to ensure structural integrity under repetitive casting and retrieval loads.

The embodiment shown in FIGS. 26 and 27 provides a visual representation of the offset swivel connector 226A in both front and side elevation views, demonstrating how the bend junction 226C realigns the lower linkage interface 226D relative to the hand line axis. This offset configuration maintains smooth rotational engagement of the outer ring coupler while transferring retrieval forces efficiently through the horn line, thereby improving casting stability, bag formation reliability, and overall mechanical performance of the cast net retrieval system.

In a preferred embodiment, the cast net webbing 104 may include a bottom section having smaller mesh (i.e., smaller openings defined by the net webbing 104, for example ⅝ inch mesh openings, extending from the weighted lead line 102C for a distance of 10 to 16 inches above the weighted lead line 102C. Above the bottom section of smaller mesh, the net webbing 104 then transitions to a larger mesh portion, for example 1 inch mesh openings (or, e.g., 1.5 inch or 2 inch mesh openings), above the smaller mesh portion. As used herein, mesh size is referred to as mesh openings, as understood by those of ordinary skill in the art. This arrangement minimizes snags upon underwater obstructions (such as sticks that would otherwise penetrate the smaller mesh portion 402 of the net webbing 104) while preserving overall capture efficiency, by having a smaller mesh size at the bottom of the net webbing 104 while having larger mesh size above such bottom portion of the net webbing 104. In other words, the smaller mesh at the bottom portion of the net webbing helps to prevent snags upon underwater obstructions, while the larger mesh still allows for a faster drop of the cast net dropping down underwater, thereby optimizing capture efficiency. Such embodiments help accomplish the goal of minimizing the number of snags upon underwater obstructions that would otherwise penetrate the lower portion of the net webbing 104, such as snags upon small tree branches like sticks (e.g., approximately ⅝ to ¾ inch diameter sticks), because the smaller mesh disposed at the bottom portion of the net webbing 104 prevents such underwater sticks from penetrating into the net webbing 104. As such, embodiments of the invention further assist in more efficient retrieval of cast net devices from the water because the smaller sticks (described above) have not penetrated the net webbing 104.

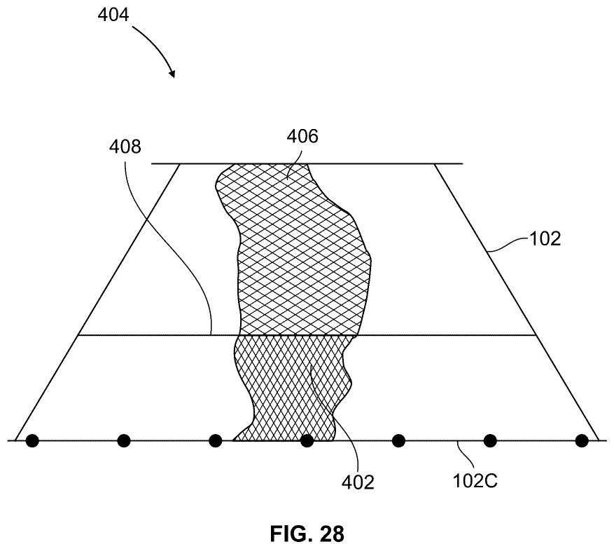

Referring now to FIG. 28, the cast net body 102 includes a dual-mesh net webbing 404 configured to improve retrieval performance and reduce snagging on underwater structures. The net webbing 404 terminates at a weighted lead line 102C and extends upwardly toward the central horn 106, defining a lower annular band 402 and an upper annular band 406.

The lower annular band 402 is formed of smaller-mesh material, preferably comprising monofilament nylon having openings of approximately five-eighths (⅝) inch. Preferably, the lower annular band 402 extends vertically for about ten (10) to sixteen (16) inches above the weighted lead line 102C. The smaller mesh openings in the lower annular band 402 inhibit snagging of the cast net on branches, sticks, and rocks during retrieval while maintaining sufficient water permeability for rapid sink rate.

The upper annular band 406 is contiguous with and positioned above the lower annular band 402. The upper annular band 406 includes larger mesh openings of approximately one inch or greater, thereby reducing the total material mass of the upper portion of the net webbing 404 and improving throw distance and radial expansion during deployment. The differential mesh sizing between the lower annular band 402 and the upper annular band 406 provides an optimal balance between castability and snag resistance.

A transition seam 408 joins the lower annular band 402 to the upper annular band 406. The transition seam 408 is preferably formed as a circumferential joint by intertwining or heat-bonding filaments of the respective mesh sections, producing a continuous webbing that uniformly distributes tensile loads during retrieval. The transition seam 408 also maintains consistent radial spacing of the braille lines 102A through the region of mesh change.

In one embodiment, the lower annular band 402 is constructed from a smaller-gauge monofilament or polymeric braid selected from nylon, polyester, or polyethylene, having increased abrasion resistance relative to the filament material of the upper annular band 406. The heavier gauge of the lower annular band 402 resists fraying and premature breakage under repeated contact with abrasive underwater surfaces.

The top edge of the net webbing 404 is preferably sewn or molded directly into a bottom ring of the central horn 106, thereby forming a reinforced attachment joint that prevents slippage and distortion of the net webbing 404 relative to the central horn 106 during both casting and retrieval cycles.

During operation, the dual-mesh configuration promotes efficient water flow through the upper annular band 406 while maintaining a dense capture zone within the lower annular band 402. The smaller mesh of the lower annular band 402 prevents escape of smaller fish species and simultaneously reduces snagging incidents during bottom contact. The larger mesh of the upper annular band 406 facilitates rapid collapse of the net webbing 404 into the bag-net configuration upon retrieval of the horn line.

This dual-mesh arrangement thus enhances both deployment and recovery performance of the cast net while maintaining structural compatibility with existing retrieval systems, including the dual-line and embedded horn-line configurations described elsewhere herein.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., upper, lower, third, etc.) is for distinction and not counting. For example, the use of “third” does not imply there must be a corresponding “upper” or “lower.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an device or system or a component of an device or system being adapted to, arranged to, capable of, configured to, enabled to, operable to, or operative to perform a particular function encompasses that device, system, or component, whether or not it or that particular function is activated, turned on, or unlocked, as long as that device, system, or component is so adapted, arranged, capable, configured, enabled, operable, or operative.

Except as may be expressly otherwise indicated, the article “a” or “an” if and as used herein is not intended to limit, and shall not be construed to limit, the meaning to a single one of the referenced item, but shall be interpreted to mean “one or more”of the referenced item.

The spirit and scope of the appended claims should not be limited to the description of the preferred versions contained herein, but rather encompass all modifications and variations consistent with the claims and their equivalents.

1. An embedded horn line cast net retrieval device comprising:
a cast net body having a central horn connected to a net webbing having a weighted lead line at a distal end thereof, wherein said cast net body is adapted to be thrown by a user into a water body for fishing;
a hand line having a proximal end opposite a distal end, the hand line having a proximal portion opposite a distal portion, the hand line having an inner longitudinal passageway through which a horn line slidably extends;
a swivel connector disposed at the distal end of the hand line, said swivel connector comprising a hollow cylindrical rod having a top section and having a lower section having a smooth outer surface around which an outer ring coupler pivotally engages the hollow cylindrical rod,
the outer ring coupler having an opposing pair of linkage arms, each linkage arm operatively connected to a respective set of a plurality of braille lines slidably extending through said central horn of the cast net body, the plurality of braille lines having respective distal ends connected to the weighted lead line;
the horn line having a proximal end opposite a distal end, the horn line having a proximal portion opposite a distal portion,
the proximal portion of the horn line extending out of a first exit aperture defined by the hand line, said first exit aperture disposed at the proximal portion of the hand line,
the proximal end of the horn line fixed to the proximal end of the hand line,
the distal portion of the horn line slidably extending through the hollow cylindrical rod of the swivel connector,
the distal end of said horn line operatively connected to the central retention aperture of the central horn, the horn line adapted to exert an uplifting force upon the central horn and the connected net webbing upon a horn line pulling by the user through the swivel connector and through the inner longitudinal passageway of the hand line, said uplifting force configured to alleviate tension in said braille lines when the weighted lead line is snagged upon an underwater obstruction.

2. The embedded horn line cast net retrieval device of claim 1, said horn line further comprising a horn line stop fixed to the horn line within said hand line, said horn line stop disposed above the hollow cylindrical rod of the swivel connector, wherein said horn line stop is sized and configured as having a diameter greater than a diameter of the hollow cylindrical rod.

3. The embedded horn line cast net retrieval device of claim 2, wherein the horn line stop is clamped onto the horn line.

4. The embedded horn line cast net retrieval device of claim 2, wherein the horn line stop is formed integrally with the horn line by molding.

5. The embedded horn line cast net retrieval device of claim 2, wherein the horn line stop comprises a diameter larger than a diameter of a top of the hollow cylindrical rod of the swivel connector, said horn line stop cooperative to limit axial translation of the horn line through the hand line during cast net deployment.

6. The embedded horn line cast net retrieval device of claim 1, wherein a top section of the hollow cylindrical rod comprises outer annular ridges adapted for frictional engagement by the distal end of the hand line.

7. The embedded horn line cast net retrieval device of claim 5, further comprising a compression ring disposed around the distal end of the hand line around, said compression ring connecting the distal end of the hand line around the top section of the hollow cylindrical rod of the swivel connector.

8. The embedded horn line cast net retrieval device of claim 1, the hand line further comprising at least one weight embedded within the hand line, said at least one weight disposed above the hollow cylindrical rod of the swivel connector, said at least one weight having a hollow cylindrical body through which the horn line is adapted to slidably move.

9. The embedded horn line cast net retrieval device of claim 1, the horn line comprising a colored marker near a proximal end thereof, said colored marker indicative of a length of horn line sufficiently pulled out of either the first exit aperture or one of the lateral access slots of the hand line adapted to indicate alleviated tension in said braille lines.

10. An embedded horn line cast net retrieval device comprising:
a cast net body having a central horn connected to a net webbing having a weighted lead line at a distal end thereof, wherein said cast net body is adapted to be thrown by a user into a water body for fishing;
a hand line having a proximal end opposite a distal end, the hand line having a proximal portion opposite a distal portion, the hand line defining an inner longitudinal passageway through which a horn line slidably extends;
a swivel connector disposed at the distal end of the hand line, said swivel connector comprising a hollow cylindrical rod having a top section and having a lower section having a smooth outer surface around which an outer ring coupler pivotally engages the hollow cylindrical rod,
the outer ring coupler having an opposing pair of linkage arms, each linkage arm operatively connected to a respective set of a plurality of braille lines slidably extending through said central horn of the cast net body, the plurality of braille lines having respective distal ends connected to the weighted lead line;
the horn line having a proximal end opposite a distal end, the horn line having a proximal portion opposite a distal portion,
the proximal portion of the horn line extending out of a first exit aperture of the hand line, said first exit aperture disposed at the proximal portion of the hand line,
the proximal end of the horn line fixed to the proximal end of the hand line,
the distal portion of the horn line slidably extending through the hollow cylindrical rod of the swivel connector;
a plurality of intermediate collars embedded within an inner longitudinal passageway of the hand line, said plurality of intermediate collars spaced sequentially and adapted to provide slidable engagement of the horn line through said plurality of intermediate collars through said hand line;
a plurality of lateral slots defined by the hand line, said plurality of slots spaced sequentially along the hand line in alignment with plurality of intermediate collars, said plurality of lateral slots configured to exposed respective portions of the horn line adapted for a pulling of the horn line by a user at sequential points along the hand line;
the distal end of said horn line operatively connected to the central retention aperture of the central horn, the horn line adapted to exert an uplifting force upon the central horn and the connected net webbing upon a horn line pulling by the user through the swivel connector and through the inner longitudinal passageway of the hand line, said uplifting force configured to alleviate tension in said braille lines when the weighted lead line is snagged upon an underwater obstruction.

11. The device of claim 10, further comprising a proximal coupler disposed within a distal portion of the hand line, said proximal coupler disposed above said swivel connector, said horn line further comprising a horn line stop fixed to the horn line within said hand line, said horn line stop disposed above said proximal coupler and adapted to restrict outward movement of the horn line from within the inner longitudinal passageway of the hand line.

12. The device of claim 10, wherein the intermediate collars are composed of low-friction material.

13. The device of claim 10, wherein the horn line includes a color-coded segment to indicate operational alignment.

14. An embedded horn line cast net retrieval comprising:
a cast net body having a central horn connected to a net webbing having a weighted lead line at a distal end thereof, the central horn defining a central retention aperture, wherein said cast net body is adapted to be thrown by a user into a water body for fishing;
a hand line having a proximal end opposite a distal end;
a swivel connector disposed at the distal end of the hand line, said swivel connector comprising a hollow cylindrical rod having a top section comprising ridges and a lower section having a smooth outer surface around which an outer coupler pivotally engages the hollow cylindrical rod,
the outer coupler having an opposing pair of linkage arms, each linkage arm operatively connected to a respective set of a plurality of braille lines slidably extending through said central horn of the cast net body, the plurality of braille lines having respective distal ends connected to the weighted lead line;
a horn line having a proximal end opposite a distal end, said proximal end of said horn line comprising a horn line stop disposed atop said swivel connector;
the distal end of said horn line operatively connected to the central retention aperture of the central horn, the horn line stop adapted to limit axial movement of the horn line through the swivel connector and respective axial movement of the central horn upon a casting of the embedded horn line cast net retrieval device by a user, said limitation of axial movement configured to form a bag net formation.

15. A cast net comprising:
a cast net body having a net webbing terminating at a weighted lead line;
a central horn; and a plurality of braille lines operatively connected between the central horn and the net webbing;
wherein the net webbing includes a lower annular band disposed directly adjacent the weighted lead line and an upper annular band contiguous with and located above the lower annular band;
wherein the lower annular band has a first mesh opening size and the upper annular band has a second mesh opening size larger than the first mesh opening size; and
wherein the lower annular band is configured to resist snagging on underwater obstructions while maintaining cast-net deployment and retrieval performance.

16. The cast net device of claim 15, wherein the lower annular band extends vertically for about 10 to 16 inches above the weighted lead line and has mesh openings of about ⅝ inch.

17. The cast net device of claim 15, wherein the upper annular band has mesh openings of about 1 inch or greater.

18. The cast net device of claim 15, wherein the transition between the lower annular band and the upper annular band is defined by a circumferential seam that joins filaments of the respective meshes to form a continuous webbing.

19. The cast net device of claim 15, wherein the lower annular band comprises a smaller-mesh monofilament section configured to reduce lodging of sticks, branches, and debris while not materially impeding the sink rate of the cast net relative to the upper annular band.

20. The cast net device of claim 15, wherein a top edge of the net webbing is sewn directly into a bottom ring of the central horn to provide a reinforced attachment.

21. The cast net device of claim 15, wherein the lower annular band and the upper annular band are formed of polymeric filamentary material selected from nylon, polyester, polyethylene, and combinations thereof, with the filament gauge of the lower annular band being equal to or greater than that of the upper annular band to enhance abrasion resistance near the weighted lead line.
